(19) United States
(12) Patent Application Publication
(10) Pub. No.: US 2026/0280666 A1
(43) Pub. Date: Sep. 17, 2026

(54) USER EQUIPMENT (UE) COMMUNICATION RESOURCE PREDICTION FOR DETERMINING UPLINK RECEIVE BEAMS

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US); Raghu Narayan CHALLA, San Diego, CA (US)

(21) Appl. No.: 19/168,208

(22) PCT Filed: Jun. 8, 2023
(86) PCT No.: PCT/CN2023/099071

§ 371 Date: Sep. 23, 2025

(51) Int. Cl. H04B 7/06; H04L 5/00

(52) U.S. Cl. CPC H04B 7/06952; H04L 5/0005

(57) ABSTRACT

Certain aspects of the present disclosure relate to enhanced signaling designs used to support beam prediction by a user equipment (UE) as part of determining a set of uplink receive beams to be used by a network entity to receive communications from the UE. A method includes receiving one or more signals communicated in a first set of communication resources associated with a first set of beams of a network entity and sending one or more identifiers of a second set of communication resources associated with a second set of beams of the network entity, wherein the second set of communication resources are predicted based on measuring the one or more signals, and wherein the one or more identifiers of the second set of communication resources are associated with a set of uplink receive beams of the network entity.

### BACKGROUND

### Field of the Disclosure

Aspects of the present disclosure relate to wireless communications, and more particularly, to techniques for beam selection.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Beam selection is the process of selecting a beam pair to use for communication between a transmitter and a receiver, where a beam pair includes a transmit beam used by the transmitter to transmit a signal to the receiver and a receive beam used by the receiver to receive the signal. Conventional beam selection methods (e.g., also referred to as exhaustive searches) search each candidate beam pair, one by one, for a combination between the transmitter and the receiver that will result in a suitable value (e.g., satisfies a threshold, maximum among candidate beam pairs, etc.) of a given criterion, such as transmitter/receiver channel gain. Although the exhaustive search method helps to select a suitable transmission/reception beam pair, this method becomes impractical due to, for example, (1) the exponentially increasing search time as a number of beams and/or radiation patterns increases and/or (2) ultra-low latency requirements of different generation wireless networks.

As such, artificial intelligence (AI)/machine learning (ML) techniques have been introduced in beam selection procedures. For example, ML-aided beam pair selection may be performed using ML models trained to predict channel conditions for one or more beams or beam pairs (as opposed to individually searching/measuring each transmit/receive beam pair) to select a “best” beam pair for communication.

For example, ML model(s) configured to predict communication resources associated with a set of beams, may be deployed at a user equipment to assist the user equipment in determining a set of uplink receive beams to be used by a network entity for communication with the user equipment. Certain aspects described herein provide signaling designs that allow the user equipment to perform such beam prediction to identify a set of communication resources (e.g., associated with a set of beams) with suitable (e.g., maximum, meets a threshold, etc.) channel condition(s) (e.g., predicted one or more channel conditions) and indicate the identified set of communication resources to the network entity. The signaling designs may involve signaling between the user equipment and the network entity.

One aspect provides a method for wireless communications at a user equipment. The method includes receiving one or more signals communicated in a first set of communication resources associated with a first set of beams of a network entity. The method further includes sending one or more identifiers of a second set of communication resources associated with a second set of beams of the network entity, wherein the second set of communication resources are predicted based on measuring the one or more signals, and wherein the one or more identifiers of the second set of communication resources are associated with a set of uplink receive beams of the network entity.

Another aspect provides a method for wireless communications at a network entity. The method includes sending one or more signals in a first set of communication resources associated with a first set of beams of the network entity. The method further includes receiving one or more identifiers of a second set of communication resources associated with a second set of beams of the network entity, wherein the second set of communication resources are predicted based on the one or more signals, and wherein the one or more identifiers of the second set of communication resources are associated with a set of uplink receive beams of the network entity.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example network entity, such as an example BS, and an example user equipment (UE).

FIGS. 4A, 4B, 4C, and 4D depict various example aspects of data structures for a wireless communications network.

FIG. 5 is a diagram depicting an example of beam management.

FIG. 6 is a diagram depicting examples of beam management procedures.

FIG. 7 is a diagram depicting example architecture of a functional framework for radio access network (RAN) intelligence enabled by data collection.

FIGS. 8A and 8B are diagrams depicting example communication resource prediction for beam selection by a UE.

FIG. 9 depicts a process flow for communications in a network between a network entity and a UE for performing communication resource prediction for uplink receive beam selection.

FIG. 10 depicts another process flow for communications in a network between a network entity and a UE for performing communication resource prediction for uplink receive beam selection.

FIG. 11 depicts another process flow for communications in a network between a network entity and a UE for performing communication resource prediction for uplink receive beam selection.

FIG. 12 depicts another process flow for communications in a network between a network entity and a UE for performing communication resource prediction for uplink receive beam selection.

FIG. 13 depicts a method for wireless communications.

FIG. 14 depicts another method for wireless communications.

FIG. 15 depicts aspects of an example communications device.

FIG. 16 depicts aspects of an example communications device.

### DETAILED DESCRIPTION

Aspects of the present disclosure relate to enhanced signaling designs used to support beam prediction by a user equipment (UE) as part of determining a set of uplink receive beams to be used by a network entity to receive communications from the UE. Uplink receive beams, as described herein, correspond to spatial beams configured at an apparatus, such as a network entity, for receiving uplink signals. For example, each uplink receive beam of the set of uplink receive beams corresponds to one or more of a corresponding amplitude weighting pattern to apply to signals received over each of a plurality of antennas of the apparatus or a corresponding phase shift pattern to apply to signals received over each of the plurality of antennas of the apparatus. A “set” as discussed herein may include one or more elements. Accordingly, a set of uplink receive beams includes one or more uplink receive beams.

Beam management is an important aspect of different generation wireless networks that enables the steering of directional beams to improve the efficiency and reliability of wireless communication. In particular, efficient and reliable communication is achieved through a combination of techniques such as beamforming (e.g., a technique that uses amplitude weighting and/or phase shift patterns across multiple antennas to focus transmission or reception of wireless signals in a particular spatial direction referred to as a beam), beam selection (e.g., the process of selecting a beam pair to use for communication between a transmitter and receiver), etc. Such techniques are critical to achieving the high data rates, low latency, and/or high reliability that different generation wireless technologies, such as 5G, 5G-Advanced, and 6G, promise to deliver.

Conventional methods of beam selection include exhaustive search methods used to identify one or more beam pairs for communication. A beam pair includes a transmit beam used by a transmitter device to transmit a signal to a receiver device, and a receive beam used by the receiver device to receive the signal. For example, for downlink communication between a UE and a network entity, a beam pair includes a transmit beam (also referred to as a downlink transmit beam) used by the network entity to transmit signals to the UE, and a receive beam (also referred to as a downlink receive beam) used by the UE to receive the signals. In another example, for uplink communication between a UE and a network entity, a beam pair includes a transmit beam (also referred to as an uplink transmit beam) used by the UE to transmit signals to the network entity, and a receive beam (also referred to as an uplink receive beam) used by the network entity to receive the signals.

In particular, conventional beam selection methods search each candidate beam pair, one by one, for a combination between a transmitter and a receiver that will result in a suitable value (e.g., satisfies a threshold, maximum among candidate beam pairs, etc.) of a given criterion, such as transmitter/receiver channel gain. In an example, for each candidate beam pair, the transmitter sends one or more reference signals using the transmit beam, and the receiver receives the one or more reference signals using the receive beam. The received one or more reference signals are measured at the receiver to determine one or more channel conditions associated with the beam pair, such as signal to noise ratio (SNR), reference signal received power (RSRP), channel state information (CSI), channel gain, etc. A beam pair with one or more channel conditions that meet one or more criteria may be selected as the beam pair for communication between the receiver and the transmitter.

Although the exhaustive search method helps to find a suitable beam pair, this method presents a technical problem in that this method may become impractical. For example, the exhaustive search method may not be effective for identifying a beam pair for uplink and/or downlink communication due to both (1) the exponentially increasing search time (and resources required) as a number of beams and/or radiation patterns increases and (2) the ultra-low latency requirements (e.g., requirements to process a very high volume of data packets with an extraordinarily low tolerance for delay), for example, which are expected in 5G, 5G-Advanced, and 6G networks.

A technical solution to the aforementioned technical problems is to introduce the use of artificial intelligence (AI)/machine learning (ML) techniques in beam management, and more specifically, beam selection procedures. In particular, with the help of ML, beam pair selection may be performed more efficiently than conventional exhaustive search methods without sacrificing performance. For example, ML-aided beam pair selection may be performed using models trained to predict channel conditions for one or more beams or beam pairs (as opposed to individually searching/measuring each transmit/receive beam pair).

Aspects herein focus on cases where ML model(s) are deployed to assist in determining a set of uplink receive beams to be used by a network entity for communication with a UE. For example, an ML model, described herein, may be configured to predict communication resources associated with a set of beams (e.g., referred to as “Set A beams,” which may correspond to transmit beams) based on measuring one or more signals (e.g., associated with another set of beams, referred to as “Set B beams,” which may correspond to transmit beams) communicated in another set of communication resources. Identifiers of the predicted communication resources may be sent to the network entity. The network entity may use such identifiers to determine a set of uplink receive beams associated with the network entity that are to be used for subsequent uplink communication.

As used herein, communication resources may refer to time-frequency resources in which signals are communicated. In certain aspects, communication resources further refer to beam(s) used to transmit and/or receive the signals. In certain aspects, one or more signals transmitted in a set of communication resources are measured to determine one or more channel conditions associated with communicating in the set of communication resources. The one or more channel conditions are accordingly associated with the beam(s) used to transmit and/or receive the signals, and may be used as part of beam selection, as discussed. As used herein, to “predict communication resources” may refer to predicting what the measurement(s) of one or more signals communicated in the communication resources would be, without actually measuring any signals in the communication resources.

Certain aspects described herein provide signaling designs that allow a UE to perform beam prediction to identify a set of communication resources with suitable (e.g., maximum, meets a threshold, etc.) one or more channel conditions (e.g., predicted one or more channel conditions) and indicate the identified set of communication resources to the network entity. At the network, the set of communication resources are associated with a set of uplink receive beams of the network entity. Accordingly, the network entity may utilize the set of uplink receive beams associated with the identified set of communication resources to communicate with the UE. Thus, the UE is able to provide an indication of a preference of the UE as to the set of uplink receive beams to be used by the network entity when communicating with the UE. Such signaling designs may be used across different generation wireless networks, such as 5G, 5G-Advanced, and 6G networks. Because the signaling designs described herein support the use of AI/ML techniques in beam selection procedures, beam selection procedures may be more efficient and consume less resources than conventional approaches, without affecting overall beam selection performance.

### Introduction to Wireless Communications Networks

The techniques and methods described herein may be used for various wireless communications networks. While aspects may be described herein using terminology commonly associated with different generation wireless technologies, aspects of the present disclosure may likewise be applicable to other communications systems and standards not explicitly mentioned herein.

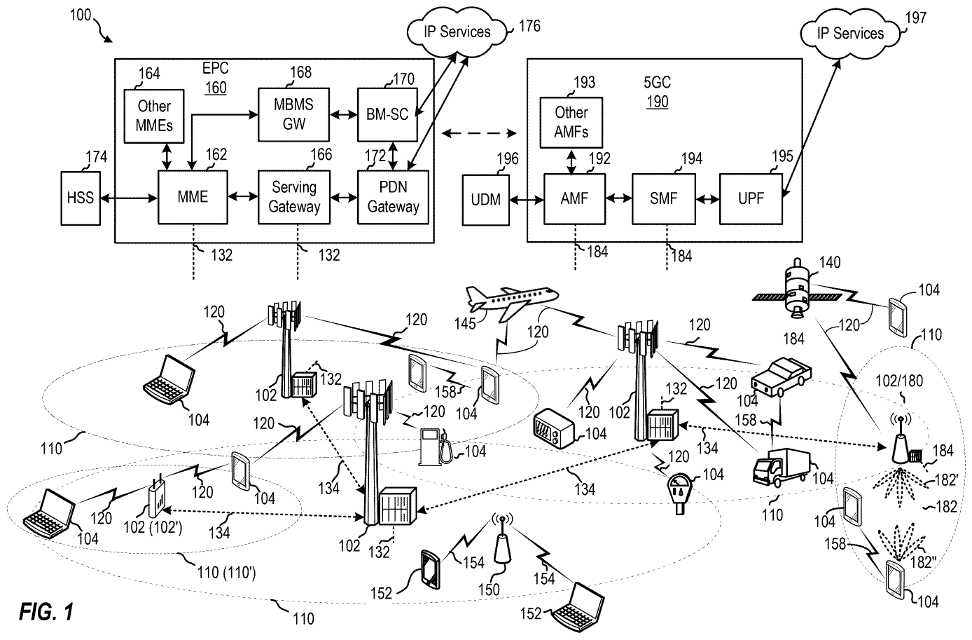

FIG. 1 depicts an example of a wireless communications network 100, in which aspects described herein may be implemented.

Generally, wireless communications network 100 includes various network entities (alternatively, network elements or network entities). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

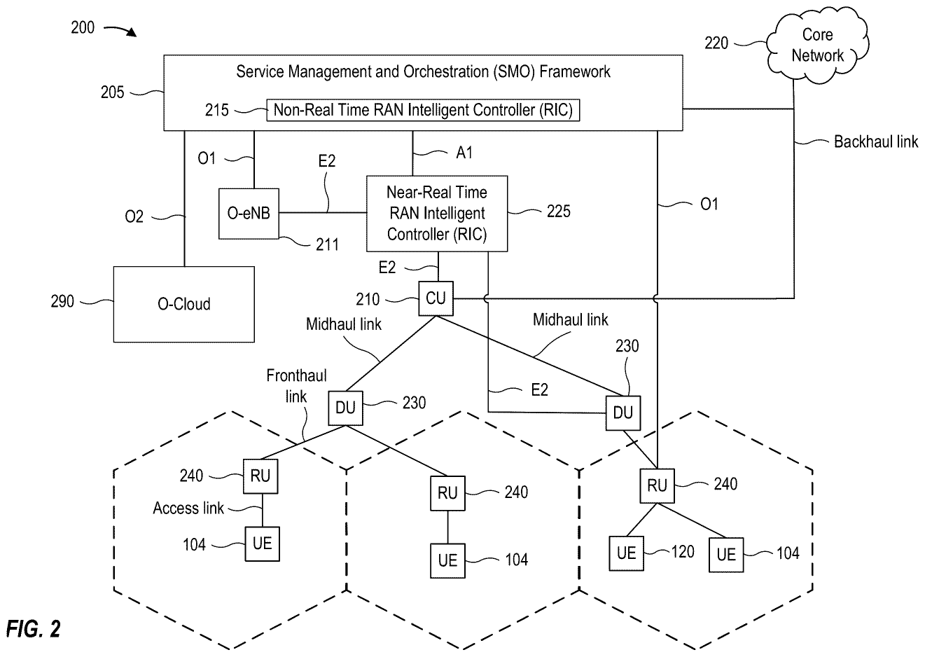

While BSs 102 are depicted in various aspects as unitary communications devices, BSs 102 may be implemented in various configurations. For example, one or more components of a BS may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a BS may be virtualized. More generally, a BS (e.g., BS 102) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as a disaggregated radio access network architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (ML) workflows including model training and updates, or policy-based guidance of applications/features in the Near-RTRIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ ML models to perform corrective actions through the SMO Framework 205 (such as reconfiguration via O1) or via creation of RAN management policies (such as A1 policies).

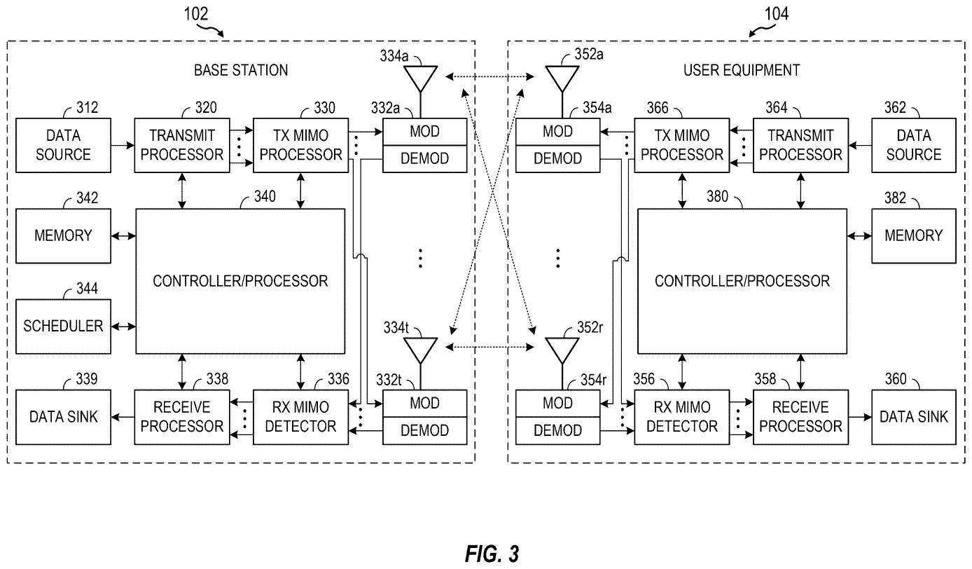

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

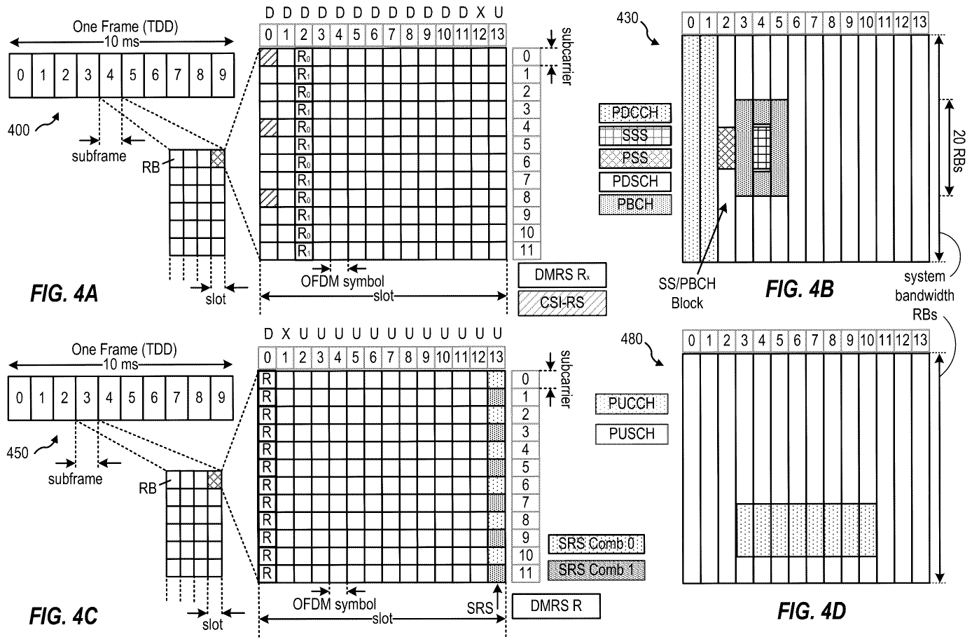

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Beam Management

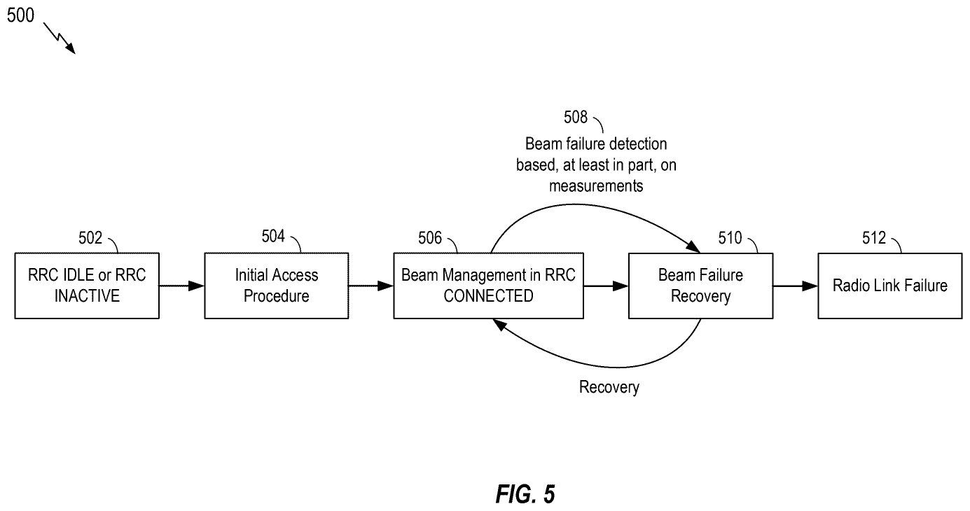

FIG. 5 is a diagram depicting example radio resource control (RRC) connection establishment and beam management 500. As shown, at 502, a user equipment (UE) may initially be in an RRC idle state (or an RRC inactivate state). An RRC idle state refers to a state of a UE where the UE is switched on but does not have any established RRC connection. The RRC idle state allows the UE to reduce battery power consumption, for example, relative to an RRC connected state. In an RRC connected state, the UE is connected to the network and radio resources are allocated to the UE.

In order to perform data transfer and/or make/receive calls, the UE needs to establish connection with a network using an initial access procedure, at 504. The initial access procedure is a sequence of processes performed between the UE and the network to establish the RRC connection. The UE may be in an RRC connected state subsequent to establishing the connection.

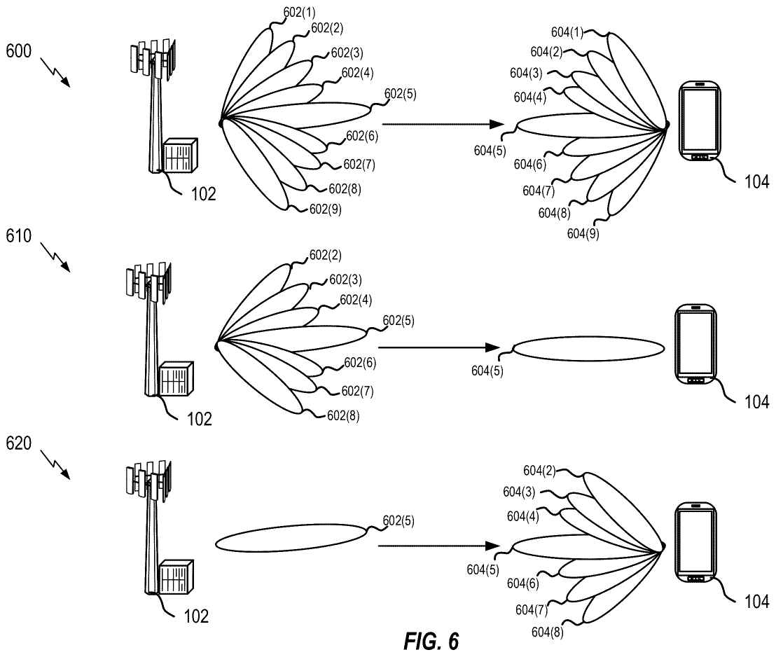

The UE may perform beam management after entering an RRC connected state. Beam management includes a set of operations used to establish and retain a (e.g., optimal) beam pair that can be used for downlink and uplink transmission/reception. A beam pair includes a transmit beam and a corresponding receive beam in one link direction. The beam management may include conventional P1, P2, and/or P3 beam management procedures, illustrated below in FIG. 6.

Beam management procedures may further include, at 508 and 510, beam failure detection and recovery operations. For example, a UE may detect a beam failure when layer 1 (L1) reference signal received power (RSRP) for a connected beam falls below a certain limit. After beam failure is detected, the UE identifies a candidate beam suitable for communication and performs beam failure recovery (BFR). If the BFR is not successful, the UE may declare a radio link failure (RLF), at 512.

FIG. 6 is a diagram illustrating examples 600, 610, and 620 of beam management procedures. As shown in FIG. 6, examples 600, 610, and 620 include a UE 104 in communication with a BS 102 in a wireless network (e.g., wireless communications network 100 in FIG. 1). However, the devices shown in FIG. 6 are provided as examples, and the wireless network may support communication and beam management between other devices (e.g., between a UE 104 and a network entity, a UE 104 and a transmission reception point (TRP), between a mobile termination node and a control node, between an integrated access and backhaul (IAB) child node and an IAB parent node, between a scheduled node and a scheduling node, and/or the like). In some aspects, the UE 104 and the BS 102 are in a connected state (e.g., RRC connected state and/or the like).

BS 102 and UE 104 may communicate to perform beam management using reference signals (RSs) (e.g., synchronization (SSBs), demodulation reference signals (DM-RSs), channel state information reference signals (CSI-RSs), etc.).

Example 600 depicts a first beam management procedure (e.g., such as a P1 CSI-RS beam management procedure). The first beam management procedure may be referred to as a beam selection procedure, an initial beam acquisition procedure, a beam sweeping procedure, a cell search procedure, a beam search procedure, and/or the like. In example 600, reference signals are configured to be transmitted from the BS 102 to UE 104. The reference signals may be configured to be periodic (e.g., using RRC signaling), semi-persistent (e.g., using media access control (MAC) control element (MAC-CE) signaling), and/or aperiodic (e.g., using downlink control information (DCI)).

As illustrated, the first beam management procedure may include BS 102 performing beam sweeping over multiple transmit (TX) beams 602(1)-602(9) (individually referred to as “transmit beam 602” and collectively referred to as “transmit beams 602”). A transmit beam, such as transmit beam 602, is a beam, or transmission configuration indicator (TCI) state, that is used by a wireless communication device (e.g., a BS 102 and/or UE 104) for transmitting signals. For example, BS 102 may transmit a reference signal using each transmit beam 602 associated with BS 102 for beam management.

To enable UE 104 to perform receive (RX) beam sweeping (e.g., a receive beam may be a beam, a TCI state, and/or spatial relation information that is used by a wireless communication device for receiving signals), BS 102 uses a transmit beam 602 to transmit (e.g., with repetitions) each reference signal at multiple times within a same resource set to enable UE 104 to sweep through receive beams 604(1)-604(9) (individually referred to as “receive beam 604” and collectively referred to as “receive beams 604”) in multiple transmission instances. For example, if BS 102 has a set of N transmit beams 602 (e.g., in this example, N is equal to nine) and UE 104 has a set of M receive beams 604 (e.g., in this example, M is equal to nine), then the reference signal may be transmitted on each of the N transmit beams 602 M times such that UE 104 receives M instances of the reference signals per transmit beam 602. As a result, the first beam management procedure helps to enable UE 104 to measure a reference signal on different transmit beams 602, using different receive beams 604, to support the selection of BS 102 transmit beams 602/UE 104 receive beam(s) 604 beam pair(s). UE 104 may report the measurements to BS 102 to enable BS 102 to select one or more beam pair(s) for communication between BS 102 and UE 104.

Example 610, illustrated in FIG. 6, depicts a second beam management procedure (e.g., such as a P2 CSI-RS beam management procedure). The second beam management procedure may be referred to as a beam refinement procedure, a BS beam refinement procedure, a TRP beam refinement procedure, a transmit beam refinement procedure, and/or the like.

As illustrated, the second beam management procedure includes BS 102 performing beam sweeping over one or more transmit beams 602 (e.g., transmit beams 602(2)-602(8)). The one or more transmit beams 602 (e.g., transmit beams 602(2)-602(8)) may be a subset of all transmit beams 602 associated with BS 102 (e.g., determined based, at least in part, on measurements reported by UE 104 in connection with the first beam management procedure). BS 102 transmits a reference signal using each transmit beam 602(2)-602(8) for beam management. UE 104 measures each reference signal using a single (e.g., a same) receive beam 604 (e.g., determined based, at least in part, on measurements performed in connection with the first beam management procedure). For example, UE 104 measures each reference signal using receive beam 604(5). As such, the second beam management procedure may enable BS 102 to select a best transmit beam 602 (e.g., from transmit beams 602(2)-602(8)) based on measurements of the reference signals (e.g., measured by UE 104 using the single receive beam 604(5)) reported by UE 104. For example, the second beam management procedure may enable BS 102 to select a best transmit beam 602 as transmit beam 602(5).

Example 620, illustrated in FIG. 6, depicts a third beam management procedure (e.g., such as a P3 CSI-RS beam management procedure). The third beam management procedure may be referred to as a beam refinement procedure, a UE beam refinement procedure, a receive beam refinement procedure, and/or the like.

As illustrated, the third beam management procedure includes BS 102 transmitting one or more reference signals using a single transmit beam 604 (e.g., determined based, at least in part, on measurements reported by UE 104 in connection with the first beam management procedure and/or the second beam management procedure). For example, BS 102 transmits one or more reference signals using transmit beam 602(5). To enable UE 104 to perform receive beam sweeping, BS 102 may use transmit beam 602(5) to transmit (e.g., with repetitions) reference signals at multiple times within a same resource set such that UE 104 can sweep through one or more receive beams 604 (e.g., receive beams 604(2)-604(8)) in multiple transmission instances. The one or more receive beams 604 (e.g., receive beams 604(2)-604(8)) may be a subset of all receive beams 604 associated with UE 104 (e.g., determined based on measurements performed in connection with the first beam management procedure and/or the second beam management procedure). The third beam management procedure helps to enable BS 102 and/or UE 104 to select a best receive beam 604 (e.g., from receive beams 604(2)-604(8)) based on reported measurements received from UE 104 (e.g., of the reference signal of the transmit beam 602(5) using the one or more receive beams 604(2)-604(8)). For example, the third beam management procedure may enable UE 104 to select a best receive beam 604 as receive beam 604(5).

FIG. 6 is provided as an example of beam management procedures for determining a beam pair with good connectivity for communication. Other examples of beam management procedures that differ from what is described with respect to FIG. 6, however, may be considered when determining beam pairs for wireless communication.

As illustrated in FIG. 6, the conventional method of beam selection, also referred to as an exhaustive search, searches each beam, one by one, for a combination between a transmitter and a receiver that will result in a maximum value of a given criterion, such as transmitter/receiver channel gain. Although the exhaustive search method helps to select a suitable transmission/reception beam pair, this method becomes impractical due to both (1) the exponentially increasing search time as a number of beams and/or radiation patterns increases and (2) ultra-low latency requirements (e.g., requirements to process a very high volume of data packets with an extraordinarily low tolerance for delay), for example, which is forecasted to be around 1-10 μs for 6G technology. As such, beam selection in beam management procedures has become a challenging task. Additionally, technical problems associated with conventional beam management procedures are further attributed to increased user mobility, increased number of antennas, and the adoption of higher frequencies in different generation wireless networks, such as 5G, 5G-Advanced, and 6G networks.

### Aspects Related to ML-Aided Beam Management Procedures

Artificial intelligence (AI), and more specifically, machine learning (ML) techniques have been introduced to help overcome the technical problems associated with conventional beam management procedures, such as those present in 5G, 5G-Advanced, and 6G networks, as described above. ML, a subdivision of AI, refers to training computer algorithms to make predictions based on experience. ML is an efficient tool that may be used to help reduce the complexity involved in generating beams and the overhead associated with beam management without sacrificing system performance. For example, with the help of ML techniques, beam selection may be performed in a fraction of the time taken by conventional exhaustive search methods and with performance comparable to that of such methods.

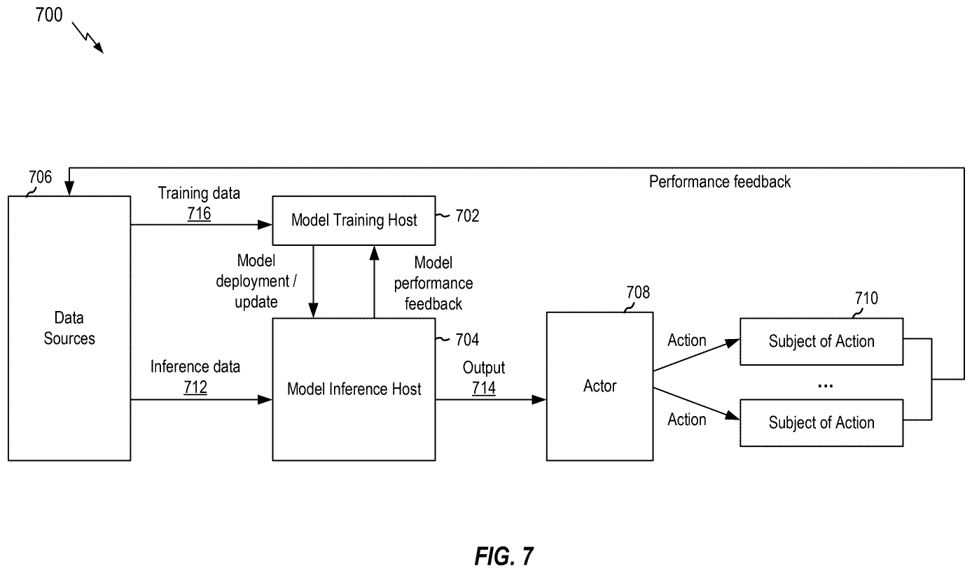

FIG. 7 is a diagram illustrating an example architecture 700 of a functional framework for radio access network (RAN) intelligence enabled by data collection. As illustrated, architecture 700 includes multiple logical entities, such as a model training host 702, a model inference host 704, data sources 706, and an actor 708. RAN intelligence enabled by ML and the associated functional framework may be utilized in various use cases, such as beam management, energy saving, load balancing, mobility management, and/or coverage optimization, among other examples. One or more benefits may be realized through the use of ML enabled RAN in such use cases.

Model inference host 704, in architecture 700, is configured to run an ML model based on inference data 712 provided by data sources 706. Model inference host 704 may produce an output 714 (e.g., a prediction) based on inference data 712, that is then provided as input into actor 708.

Actor 708 may be an element or an entity of a core network (CN) or a RAN. For example, actor 708 may be a UE (e.g., UE 104 in FIG. 1), a BS (e.g., a BS 102 in FIG. 1) or another network node (e.g., a gNB, a centralized unit (CU), a distributed unit (DU), and/or a radio unit (RU)), among other examples. Additionally, the type of actor 708 may also depend on the type of tasks performed by model inference host 704, the type of inference data 712 provided to model inference host 704, and/or the type of output 714 produced by model inference host 704.

For example, if output 714 from model inference host 704 is associated with beam management (e.g., produced from ML model(s) described in more detail below with respect to FIG. 7), actor 708 may be a UE, a DU, or an RU. As another example, if output 714 from model inference host 704 is associated with transmission and/or reception scheduling, actor 708 may be a CU or a DU.

After actor 708 receives output 714 from model inference host 704, actor 708 may determine whether to act based on the output. For example, if actor 708 is a DU or an RU and the output from model inference host 704 is associated with beam management, actor 708 may determine whether to change/modify a transmission and/or a reception beam based on output 714. If actor 708 determines to act based on output 714, actor 708 may indicate the action to at least one subject of action 710. For example, if actor 708 determines to change/modify a transmission and/or reception beam for a communication between actor 708 and the subject of action 710 (e.g., a UE), then actor 708 may transmit a beam (re-)configuration or a beam switching indication to subject of action 710. Actor 708 may modify its transmission and/or reception beam based on the beam (re-)configuration, such as switching to a new transmission and/or reception beam and/or applying different parameters for a transmission and/or reception beam, among other examples. As another example, actor 708 may be a UE, and output 714 from model inference host 704 may be associated with beam management. For example, output 714 may be one or more predicted measurement values for one or more beams. Actor 708, the UE, may determine that a measurement report (e.g., an L1 RSRP report) is to be transmitted to a BS in communication with the UE. In some cases, actor 708 and subject of action 710 are the same entity.

Data sources 706 may be configured for collecting data that is used as training data 716 for training an ML model, or as inference data 712 for feeding an ML model inference operation. In particular, data sources 706 may collect data from one or more CN and/or RAN entities, which may include subject of action 710, and provide the collected data to a model training host 702 for ML model training. For example, after a subject of action 710 (e.g., a UE) receives a beam configuration from actor 708, subject of action 710 may provide performance feedback associated with the beam configuration to data sources 706, where the performance feedback may be used by the model training host 702 for monitoring and/or evaluating the ML model performance, such as whether output 714, provided to actor 708, is accurate. In some examples, if output 714 provided to actor 708 is inaccurate (or the accuracy is below an accuracy threshold), then model training host 702 may determine to modify or retrain the ML model used by model inference host 704, such as via an ML model deployment/update.

In some aspects, an ML model is deployed at or on a network entity (e.g., such as BS 102 in FIG. 1) for purposes of spatial domain (SD), temporal domain (TD), and/or frequency domain (FD) beam prediction. More specifically, a model interference host, such as model inference host 704 in FIG. 7, may be deployed at or on the network entity for such beam prediction. The TD refers to the analytic space in which signals are conveyed in terms of time, rather than frequency. The FD refers to the analytic space in which signals are conveyed in terms of frequency, rather than time. For example, the network entity may be configured to predict downlink receive (RX) beams that are to be used by a UE for receiving downlink transmission(s) from the network entity. To enable such prediction, the UE may be required to feed back its receive beam information (e.g., beam shapes, direction, beamforming, gains, and/or the like) to the network entity.

In some other aspects, an ML model is deployed at or on a UE (e.g., such as UE 104 in FIG. 1) for purposes of SD, TD, and/or FD beam prediction. More specifically, a model inference host, such as model inference host 704 in FIG. 7, may be deployed at or on the UE for such beam prediction. A scenario where the ML model, at or on the UE, is configured to predict SD beams may be referred to as a beam management case 1, or simply “BM-Case1.” Additionally, a scenario where the ML model, at or on the UE, is configured to predict TD beams may be referred to as a beam management case 2, or simply “BM-Case2.”

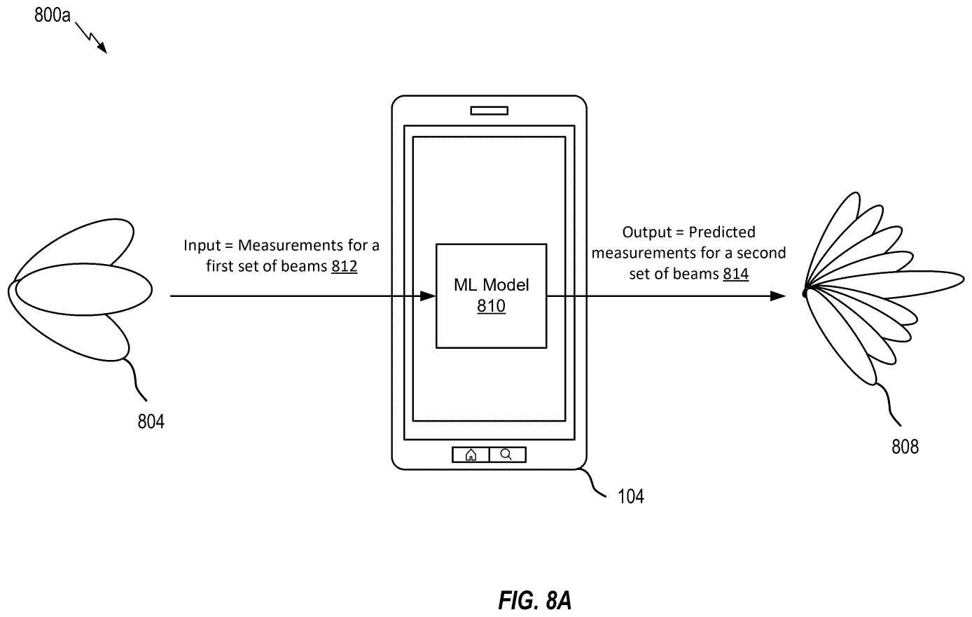

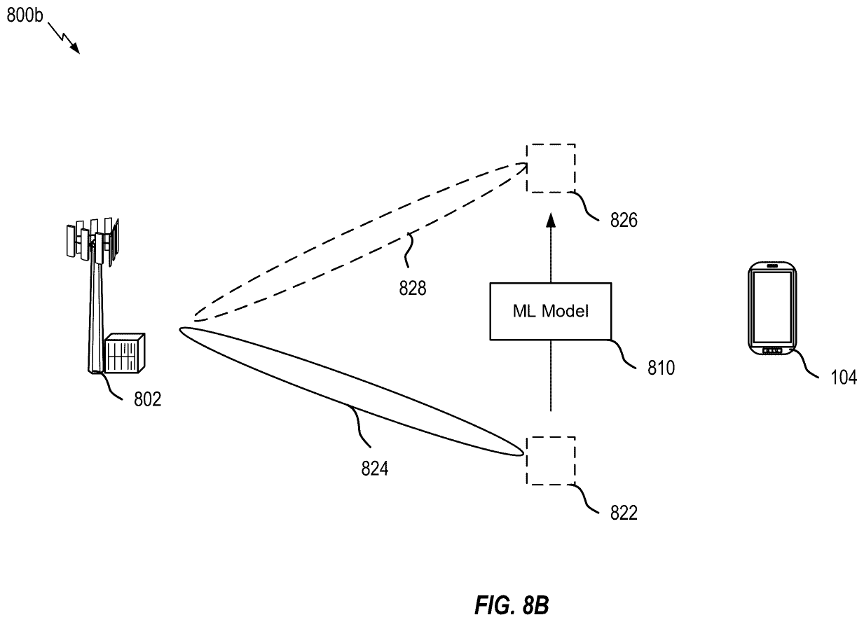

FIG. 8A is a diagram illustrating example beam prediction 800a by a UE 104. In FIG. 8A, an ML model 810 is deployed at or on UE 104 to enable UE 104 to make one or more beam predictions based on data input to ML model 810.

For example, a BS 102 may transmit one or more signals, via a first set of beams 804, in a first set of communication resources. UE 104 may perform measurements (e.g., L1 RSRP measurements and/or other measurements) of the one or more signals transmitted in the first set of communication resources, or a subset thereof, to obtain a first set of measurements 812 (sometimes referred to as parameters or channel characteristics). For example, each beam (or else a subset thereof) 804, from the first set of beams carrying the one or more signals, may be associated with one or more measurements 812 performed by UE 104. UE 104 may input the first set of measurements 812 (e.g., L1 RSRP measurement values) into ML model 810 along with information associated with the first set of beams and/or first set of communication resources (or a subset thereof). The information associated with the first set of beams may include a beam direction (e.g., a spatial direction), beam width, beam shape, and/or other characteristics of the respective beam.

ML model 810 may be configured to output one or more predictions. More specifically, ML model 810 may be configured to predict one or more measurement values 814 for a second set of communication resources 806 associated with a second set of beams 808. The one or more measurement values 814 may include predicted channel characteristics (e.g., predicted L1 RSRP measurement values) associated with the second set of communication resources 806, where the second set of communication resources 806 are associated with the second set of beams 808.

In some examples, the first set of beams 804 (e.g., that are measured) may be referred to as “Set B beams” and the second set of beams 808 (e.g., that are associated with predicted measurements for the second set of communication resources 806) may be referred to as “Set A beams.” Put another way, the “Set B beams” are a set of beams for which measurements are taken and used as inputs in ML model 810, while the “Set A beams” are a set of beams for which ML model 810 performs predictions.

In some examples, first set of beams 804 are a subset of second set of beams 808. In some other examples, first set of beams 804 and second set of beams 808 are different beams and/or may be mutually exclusive sets. For example, first set of beams 804 may include wide beams (e.g., unrefined beams or beams having a beam width that satisfies a first threshold), and second set of beams 808 may include narrow beams (e.g., refined beams or beams having a beam width that satisfies a second threshold).

Use of ML model 810 for beam prediction may reduce a quantity of beam measurements that are performed by UE 104 (e.g., compared to exhaustive search methods described above with respect to FIG. 6), thereby conserving power at UE 104 and/or network resources that would have otherwise been used to measure all beams included in at least the first set of beams.

In some aspects, this type of prediction may be referred to as a codebook-based SD selection or prediction. The codebook-based SD prediction/selection may be associated with an initial access, a secondary cell group (SCG) setup, a serving beam refinement, and/or a link quality (e.g., channel quality indicator (CQI) or precoding matrix indicator (PMI)) and interference adaptation.

As another example, an output of ML model 810 may include a point-direction, an angle of departure (AoD), and/or an angle of arrival (AoA) of a beam included in the second set of beams (e.g., the “Set A beams”). This type of prediction may be referred to as a non-codebook-based SD selection or prediction. The non-codebook-based prediction/selection may be associated with a serving beam refinement, and/or a link quality (e.g., CQI or PMI) and interference adaptation. As another example, multiple measurement reports and/or values, collected at different points in time, may be input to ML model 810. This may enable ML model 810 to output codebook-based and/or non-codebook-based predictions for a measurement value, an AoD, and/or an AoA, among other examples, of a beam at a future time. The output(s) of ML model 810, may facilitate initial access procedures, secondary cell group (SCG) setup procedures, beam refinement procedures (e.g., a P2 beam management procedure and/or a P3 beam management procedure as described above with respect to FIG. 6), link quality or interference adaptation procedures, beam failure and/or beam blockage predictions, and/or radio link failure predictions, among other examples.

In some aspects, an output of ML model 810 may include a temporal beam prediction. The TD beam prediction may be associated with a serving beam refinement, a link quality (e.g., CQI or PMI) and interference adaptation, a beam failure/blockage prediction, and/or a radio link failure (RLF) prediction.

In some aspects, ML model 810 performs SD downlink beam predictions for beams included in the “Set A beams” based on measurement results of beams included in the “Set B beams.” In some aspects, ML model 810 performs TD downlink beam prediction for beams included in the “Set A beams” based on historic measurement results of beams included in the “Set B beams.”

### Example Operations of Entities in a Communications Network for Performing Prediction of Communication Resources to Determine a Set of Uplink Receive Beams

In some aspects, an ML model is deployed for predicting communication resources to assist in determining a set of uplink receive beams to be used for communication. In certain aspects, predicting communication resources to assist in determining a set of uplink receive beams to be used for communication may be referred to as predicting uplink receive beams. For example, FIG. 8B is a diagram illustrating example communication resource prediction 800b by a UE 104 for uplink receive beam selection for a network entity 802, such as BS 102 of FIG. 1. In FIG. 8B, an ML model 810 is deployed at or on UE 104 to enable UE 104 to make one or more communication resource predictions based on data input to ML model 810. Though embodiments herein describe the use of an ML model to predict communication resources associated with a set of beams, in certain other embodiments, other prediction techniques (e.g., defined in a specification, such as 3GPP) may be used to predict the communication resources.

To perform communication resource prediction, network entity 802 may first transmit one or more signals, via a first set of beams 824, in a first set of communication resources 822. Network entity 802 may be any network entity, such as BS 102 in FIGS. 1 and 3. The first set of beams 824 may be a first set of downlink transmit beams of the network entity 802. UE 104 may measure the one or more signals transmitted in the first set of communication resources 822, to obtain a first set of measurements (sometimes referred to as parameters or channel characteristics).

For example, each signal carried via each beam in the first set of beams 824 may be associated with one or more measurements performed by UE 104. UE 104 may input the first set of measurements into ML model 810. In some aspects, information associated with the first set of beams 824 (e.g., beam direction, beam width, beam shape, and/or other characteristics) is also input into ML model 810 for communication resource prediction.

ML model 810 is configured to output one or more predictions, and more specifically, is configured to predict communication resources. As used herein, predicting communication resources comprises predicting one or more parameters associated with the communication resources. For example, based on the one or more measurements provided as input into ML model 810, ML model 810 predicts one or more parameters (e.g., measurement values and/or channel characteristics) for a second set of communication resources 826 associated with a second set of beams 828. In certain aspects, the second set of beams 828 corresponds to a second set of downlink transmit beams of the network entity 802. For example, the ML model 810 predicts what measurement(s) of one or more signals would be if they were transmitted by network entity 802 on the second set of communication resources 826 using the second set of beams 828. In certain aspects, the second set of beams 828 corresponds to a set of uplink receive beams of the network entity 802. For example, the ML model 810 predicts measurement(s) of one or more signals if they had been transmitted by network entity 802 on transmit beams that have the same spatial configuration as the set of uplink receive beams.

In some aspects, UE 104 sends one or more identifiers of the second set of communication resources 826 to network entity 802. Network entity 802 may determine a set of uplink receive beams to use for receiving subsequent uplink transmission(s) from UE 104 based on the second set of communication resources 826. For example, network entity 802 may store or have access to information, such as a mapping, that associates/maps the second set of communication resources 826 with the set of uplink receive beams. In certain aspects, UE 104 may not have information regarding the association of the set of uplink receive beams with the second set of communication resources 826.

In order to use ML models for predicting communication resources at a UE to (1) overcome technical problems associated with conventional beam selection procedures, such as those described above with respect to FIG. 6, as well as (2) avoid requiring a UE to share information about one or more receive beams of the UE (e.g., beam shapes, direction, beamforming, etc.), aspects described herein provide one or more signaling designs that allow the UE to perform communication resource prediction and by indicating a set of communication resources, as well as be able to implicitly or explicitly indicate preferred uplink receive beam(s) to a network entity. Such signaling designs may be used across different generation wireless networks, such as 5G, 5G-Advanced, and 6G networks.

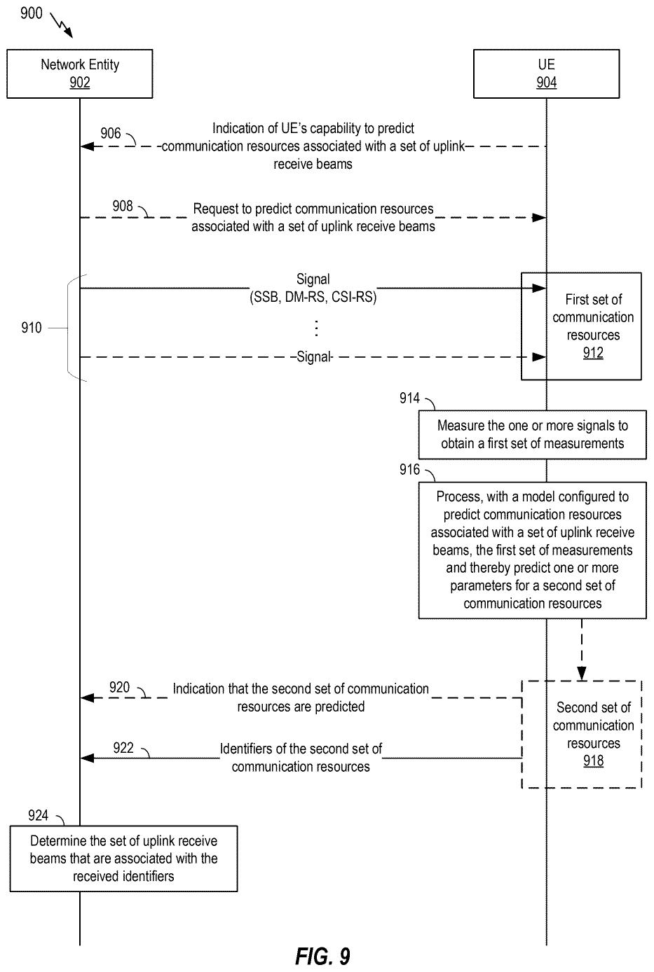

The signaling designs described herein are provided in FIGS. 9, 10, 11, and 12. Each of FIGS. 9, 10, 11, and 12 depicts a process flow 900, 1000, 1100, 1200, respectively, for communications in a network between a network entity 902, 1002, 1102, 1202 and a UE 904, 1004, 1104, 1204. In some aspects, network entities 902, 1002, 1102, 1202 are examples of BS 102 depicted and described with respect to FIGS. 1 and 3 or a disaggregated BS depicted and described with respect to FIG. 2. Similarly, UEs 904, 1004, 1104, 1204 may be examples of UE 104 depicted and described with respect to FIGS. 1 and 3. However, in other aspects, UEs 904, 1004, 1104, 1204 may be another type of wireless communications device and network entities 902, 1002, 1102, 1202 may be another type of network entity or network node, such as those described herein.

As illustrated in process flow 900 of FIG. 9, at step 910, a network entity 902 sends, to a UE 904, one or more signals in a first set of communication resources 912. The one or more signals may include SSBs, DM-RSs, and/or CSI-RSs (e.g., non-zero power (NZP)-CSI-RSs). The first set of communication resources 912 may be associated with a first set of beams used to transmit the signal(s), such as one or more downlink transmit beams of network entity 902. As used herein, a set of communication resources may include one or more communication resources. Further, as used herein, a set of beams may include one or more beams.

Optionally, prior to step 910, at step 906, UE 904 may transmit an indication to network entity 902 that UE 904 is capable of predicting communication resources (e.g., associated with a set of uplink receive beams). In other words, UE 904 indicates, to network entity 902, that UE 904 is capable of predicting communication resources (e.g., via use of ML model(s)). In certain aspects, the indication indicates the type(s) of prediction the UE 904 is capable of performing, such as SD, TD, and/or FD prediction. In some aspects, network entity 902 transmits the one or more signals to UE 904, at 910, in response to receiving such information about UE 904's capability.

At 914, UE 904 measures the one or more signals received in the first set of communication resources 912 to obtain a first set of measurements. The first set of measurements may include RSRP, signal to interference plus noise (SINR), and/or the like.

At step 916, UE 904 processes, with a model (e.g., ML model at or on UE 904) configured to predict communication resources, the first set of measurements (e.g., obtained at 914). Processing the first set of measurements with the model thereby predicts one or more parameters for one or more sets of communication resources, including a second set of communication resources 918. The second set of communication resources 918 are associated with a second set of beams of network entity 902.

In some aspects, the second set of beams of network entity 902, associated with the second set of communication resources 918, is a set of downlink transmit beams of network entity 902 used to actually transmit one or more second signals (e.g., SSBs, DM-RSs, and/or CSI-RSs), though UE 904 may not measure the one or more second signals, but instead predict the second set of communication resources. Accordingly, the second set of communication resources 918 may be an actual set of communication resources used for communicating the second one or more signals. In some aspects, the second set of beams of network entity 902 is a set of downlink transmit beams of network entity 902, which network entity 902 does not use to transmit one or more second signals. Accordingly, the second set of communication resources 918 may be a virtual set of communication resources (also referred to as virtual resources) not actually used for communicating the second one or more signals. In some aspects, the second set of beams of network entity 902 is a set of uplink receive beams of network entity 902.

In some aspects, the UE 904 selects the second set of communication resources 918 from a plurality of sets of communication resources, such as based on the second set of communication resources 918 having a suitable value (e.g., satisfies a threshold, maximum among the plurality of sets of communication resources, etc.) of a given criterion, such as measured channel quality (e.g., RSRP, SINR, and/or the like).

Optionally, prior to step 910, at step 908, network entity 902 may send, to UE 904, a request to predict communication resources. As such, processing the first set of measurements with the model, at step 916, may be based on receiving the request, at step 908. In some aspects, the request to predict communication resources indicates one or more types of prediction (e.g., SD, TD, and/or FD prediction) the UE 904 should perform to predict the communication resources. In some aspects, the one or more types are selected by network 902 among the type(s) of prediction the UE 904 is capable of performing, such as SD, TD, and/or FD prediction, indicated at 906.

At step 922, UE 904 sends, to network entity 902, identifier(s) of the second set of communication resources 918 associated with the second set of beams. The identifier(s) of the second set of communication resources 918 may be sent to network entity 902 via a CSI report and/or a MAC-CE. For example, UE 904 may receive, from network entity 902, an RRC message configuring a CSI report setting (e.g., reportQuantity) that explicitly indicates that identifier(s) of the second set of communication resources 918 are to be reported by UE 904 via a CSI report. Optionally, at step 920, prior to sending the identifier(s) at step 922, UE 904 may send an indication, to network entity 902, that the second set of communication resources are predicted by UE 904.

In some aspects, in addition to sending the identifier(s) of the second set of communication resources 918 at step 922, UE 904 further transmits additional feedback information associated with the second set of communication resources 918. The additional feedback information may be included in a same or different message than the message used to indicate the identifier(s) of the second set of communication resources 918. In some aspects, the additional feedback information includes a predicted RSRP (e.g., L1-RSRP predicted in SD, TD, and/or FD) for downlink and/or uplink communication associated with the second set of communication resources 918. In some aspects, the additional feedback information includes a predicted SINR (e.g., L1-SINR predicted in SD, TD, and/or FD) for downlink and/or uplink communication associated with the second set of communication resources 918. In some aspects, the additional feedback information includes a predicted angle of arrival (AoA) (e.g., predicted in SD, TD, and/or FD) for downlink and/or uplink communication associated with the second set of communication resources 918. In some aspects, the additional feedback information includes a predicted angle of departure (AoD) (e.g., predicted in SD, TD, and/or FD) for downlink and/or uplink communication associated with the second set of communication resources 918. In some aspects, the predicted RSRP, SINR, AoA, and/or AoD may be predicted using the ML model, such as using one or more of SD, TD, and/or FD as discussed herein. In particular, the RSRP, SINR, AoA, and/or AoD may be parameters predicted for the second set of communication resources 918, such as based on measuring the first set of communication resources 912.

The identifier(s) of the second set of communication resources are associated with a set of uplink receive beams of network entity 902. As such, at 924, network entity 902 determines the set of uplink receive beams that are associated with the received identifier(s) subsequent to receiving these identifier(s).

For example, in aspects where the second set of beams of network entity 902, associated with the second set of communication resources, is a set of downlink transmit beams of network entity 902 (e.g., used or not used to transmit one or more second signals), network entity 902 may determine the set of uplink receive beams associated with the second set of communication resources based on a mapping of downlink transmit beams and/or communication resources to uplink receive beams, maintained by network entity 902.

As another example, in aspects where the second set of beams of network entity 902, associated with the second set of communication resources, is a set of uplink receive beams of network entity 902, network entity 902 may determine the set of uplink receive beams associated with these communication resources based on a mapping of communication resources to uplink receive beams of network entity 902, maintained by network entity 902.

Network entity 902 may use the set of uplink receive beams for subsequent uplink communication with UE 904.

In certain aspects, UE 904, such as at step 916, further selects an appropriate uplink transmit beam corresponding to the second set of communication resources 918. For example, the prediction of the second set of communication resources 918 may be based on the assumption of using the uplink transmit beam.

In some cases, prior to step 916 (e.g., such as at step 908) network entity 902 may send an indication of one or more sets of communication resources, including the second set of communication resources, that UE 904 should predict at 916. In certain aspects, network entity 902 sends an indication of one or more sets of beams associated with the one or more sets of communication resources, including the second set of beams associated with the second set of communication resources. The UE 904 may use such information as input to the ML model to predict the one or more sets of communication resources, including the second set of communication resources.

In some aspects, the indication of the second set of beams, sent to UE 904, includes an indication of beam direction(s), beam width(s), and/or beamforming gain(s) associated with the second set of beams. In some aspects, the indication of the second set of beams, sent to UE 904, includes associations and/or offsets between parameters(s) of the first set of beams (e.g., used to transmit the one or more signals at step 910) and the second set of beams. Parameters of the first set of beams and/or the second set of beams include beam direction(s), beam width(s), and/or beamforming gain(s) associated with the respective first set of beams or the respective second set of beams. For example, the indication of the second set of beams, sent to UE 904, may include a beam width difference between a beam in the first set of beams (e.g., including one beam) and a beam in the second set of beams (e.g., including one beam). In some aspects, the indication of the second set of beams, sent to UE 904, is sent via an RRC message, a CSI report setting, an aperiodic CSI report configuration, a MAC-CE, or a DCI (e.g., within dedicated field(s) of the DCI). For example, the indication may be sent in an RRC message as a CSI report setting, a CSI resource setting, CSI resource sets, and/or prediction resource sets associated with a CSI/L1-report. For example, the indication may be sent in a CSI-AssociatedReportConfigInfo with respect to an aperiodic CSI/L1-report. As another example, the indication may be sent in a MAC-CE activating semi-persistent CSI/L1-reports.

In some cases, at 916, UE 904 is configured to perform only SD prediction, or pure SD prediction (e.g., via use of the ML model(s)). In such cases, the first set of beams (e.g., associated with the first set of communication resources where one or more signals were transmitted by network entity 902, at step 910) and the second set of beams (e.g., associated with the second set of communication resources, predicted by UE 904, at step 916) correspond to different sets of beams. Different sets of beams may refer to: 1) beams that are fully non-overlapping and completely spatially separate, or 2) beams that partially overlap spatially, but do not fully overlap spatially, meaning at least one beam occupies a spatial region not occupied by another beam. In particular, different beams may correspond to use of different antenna panels/elements for communication, different spatial filters applied, and/or the like. Further, the first set of communication resources and the second set of communication resources correspond to same time and frequency resources.

In some cases, UE 904 is configured to perform only TD prediction, or pure TD prediction (e.g., via use of the ML model(s)). In such cases, the prediction of the second set of communication resources is based on historical measurements of communication resources corresponding to the same frequency and spatial resources as the second set of communication resources. For example, in these cases, the first set of beams and the second set of beams correspond to the same set of beams. The same set of beams may refer to beams that are fully spatially overlapping, and occupy the same spatial region. In particular, the same beams may correspond to use of the same antenna panels/elements for communication, identical spatial filters applied, and/or the like. The first set of communication resources and the second set of communication resources correspond to the same frequency resources but different time resources. For example, the first set of communication resources may occur earlier in time than the second set of communication resources. The second set of communication resources may correspond to one or more future TD occasions.

In some cases, UE 904 is configured to perform SD and TD prediction (e.g., via use of the ML model(s)). In such cases, the prediction of the second set of communication resources is based on historical measurements of communication resources corresponding to the same frequency resources as the second set of communication resources. For example, in these cases, the first set of beams and the second set of beams correspond to different sets of beams. The first set of communication resources and the second set of communication resources correspond to the same frequency resources but different time resources. For example, the first set of communication resources may occur earlier in time than the second set of communication resources.

In some cases, UE 904 is configured to perform only FD prediction, or pure FD prediction (e.g., via use of the ML model(s)). In such cases, the first set of beams and the second set of beams correspond to the same set of beams in the SD (e.g., have identical antenna elements and/or identical spatial transmitter filters). Further, the first set of communication resources and the second set of communication resources correspond to the same time resources but different frequency resources (e.g., different component carriers, different cells, different frequency bands, different frequency ranges (FRs), etc.). Pure FD prediction may be applicable to cross-band/component carrier (CC) predictions.

In some cases, UE 904 is configured to perform SD and FD prediction (e.g., via use of the ML model(s)). In such cases, the first set of beams and the second set of beams correspond to different sets of beams. Further, the first set of communication resources and the second set of communication resources correspond to the same time resources but different frequency resources. SD and FD prediction may be applicable to cross-frequency range predictions and/or predictions for L1/layer 2 (L2)-triggered mobility.

In some cases, UE 904 is configured to perform FD and TD prediction (e.g., via use of the ML model(s)). In such cases, the first set of beams and the second set of beams correspond to a same set of beams. Further, the first set of communication resources and the second set of communication resources correspond to different frequency and time resources. For example, the first set of communication resources may occur earlier in time than the second set of communication resources. The second set of communication resources may correspond to one or more future TD occasions.

In some cases, UE 904 is configured to perform SD, TD, and FD prediction (e.g., via use of the ML model(s)). In such cases, the first set of beams and the second set of beams correspond to different sets of beams. Further, the first set of communication resources and the second set of communication resources correspond to different frequency and time resources. For example, the first set of communication resources may occur earlier in time than the second set of communication resources. The second set of communication resources may correspond to one or more future TD occasions.

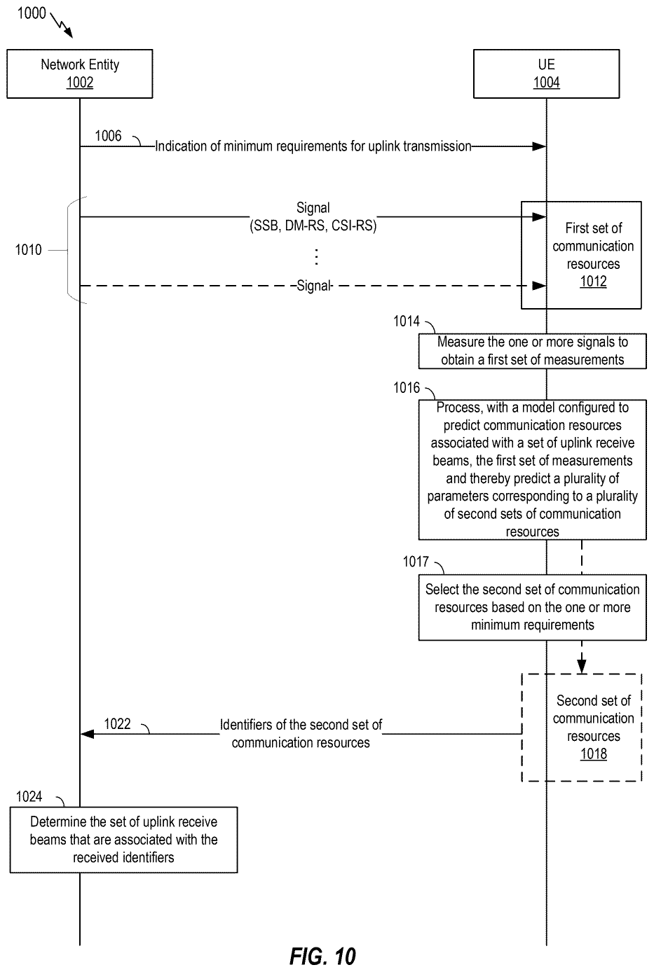

In some aspects, the predicted second set of communication resources indicated, by the UE for the network entity, is further determined based on minimum requirements of the network entity. For example, the second set of communication resources is selected among a plurality of sets of communication resources predicted by the UE. The UE selects as the second set of communication resources a set of communication resources that meets the minimum requirements of the network entity. Determination of the second set of communication resources based on minimum requirements of the network entity is illustrated in process flow 1000 of FIG. 10. Steps 1010, 1014, 1016, 1022, and 1024 in process flow 1000 are similar (e.g., identical) to steps 910, 914, 916, 922, and 924 in process flow 900 of FIG. 9. However, unlike process flow 900, in process flow 1000, prior to a network entity (e.g., network entity 1002) sending one or more signals, to a UE (e.g., UE 1004) in a first set of communication resources, such that a second set of communication resources may be predicted, at step 1006, network entity 1002 sends, to UE 1004, an indication of requirements for uplink transmission from UE 1004 to network entity 1002.

The minimum requirements indicated by network entity 1002, at step 1006, may include spectral efficiency requirements, throughput requirements, signal to noise ratio (SNR) requirements, and/or RSRP requirements. In certain aspects, to meet the minimum requirements, the predicted second set of communication resources must have predicted spectral efficiency, predicted throughput, predicted SNR, and/or predicted RSRP that meet the minimum requirements.

The indication of the minimum requirements may be sent via an RRC message, a CSI report setting, an aperiodic CSI report configuration, a MAC-CE, or DCI (e.g., within dedicated field(s) of the DCI). For example, the indication may be sent in an RRC message as a CSI report setting associated with a CSI report. As another example, the indication may be sent in a CSI-AssociatedReportConfigInfo with respect to an aperiodic CSI/L1-report. As another example, the indication may be sent in a MAC-CE activating semi-persistent CSI/L1-reports or through other dedicated MAC-CEs. In certain aspects, an absolute value for one or more of the minimum requirements may be sent. In certain aspects, a relative value for one or more of the minimum requirements may be sent, such as relative to another value. The UE 1004 may further need to select an appropriate uplink transmit beam to transmit in the uplink to meet the minimum requirements.

For example, network entity 1002 and/or UE 1004 may have previously predicted and/or measured communication resources to determine a beam pair for downlink communication, including a downlink transmit beam of network entity 1002 and a downlink receive beam of UE 1004. One of the predicted and/or measured communication resources used to determine a beam pair for downlink communication has a best (e.g., highest) RSRP among the predicted and/or measured communication resources. In certain aspects, the RSRP requirement may be indicated, to UE 1004, as an (e.g., positive) offset relative to the best RSRP among the predicted and/or measured communication resources for the downlink communication.

As another example, one of the predicted and/or measured communication resources used to determine a beam pair for downlink communication has a best (e.g., highest) spectral efficiency among the predicted and/or measured communication resources. In certain aspects, the spectral efficiency requirement may be indicated, to UE 1004, as an (e.g., positive) offset relative to the best spectral efficiency among the predicted and/or measured communication resources for the downlink communication.

As another example, one of the predicted and/or measured communication resources used to determine a beam pair for downlink communication has a best (e.g., highest) throughput among the predicted and/or measured communication resources. In certain aspects, the throughput requirement may be indicated, to UE 1004, as an (e.g., positive) offset relative to the best throughput among the predicted and/or measured communication resources for the downlink communication.

As another example, one of the predicted and/or measured communication resources used to determine a beam pair for downlink communication has a best (e.g., highest) SNR among the predicted and/or measured communication resources. In certain aspects, the SNR requirement may be indicated, to UE 1004, as an (e.g., positive) offset relative to the best SNR among the predicted and/or measured communication resources for the downlink communication.

Minimum requirements for network entity 1002 may be used in determining second set of communication resources 1018. For example, processing the first set of measurements, via an ML model at 1016, may result in a plurality of predictions of parameters corresponding to a plurality of sets of communication resources. As such, at step 1017, UE 1004 may select a second set of communication resources (e.g., from the plurality of sets of communication resources) based on the minimum requirements of network entity 1002. For example, UE 1004 may select a second set of communications resources associated with a spectral efficiency greater than an indicated spectral efficiency minimum required by network entity 1002, a throughput greater than an indicated throughput minimum required by network entity 1002, etc.

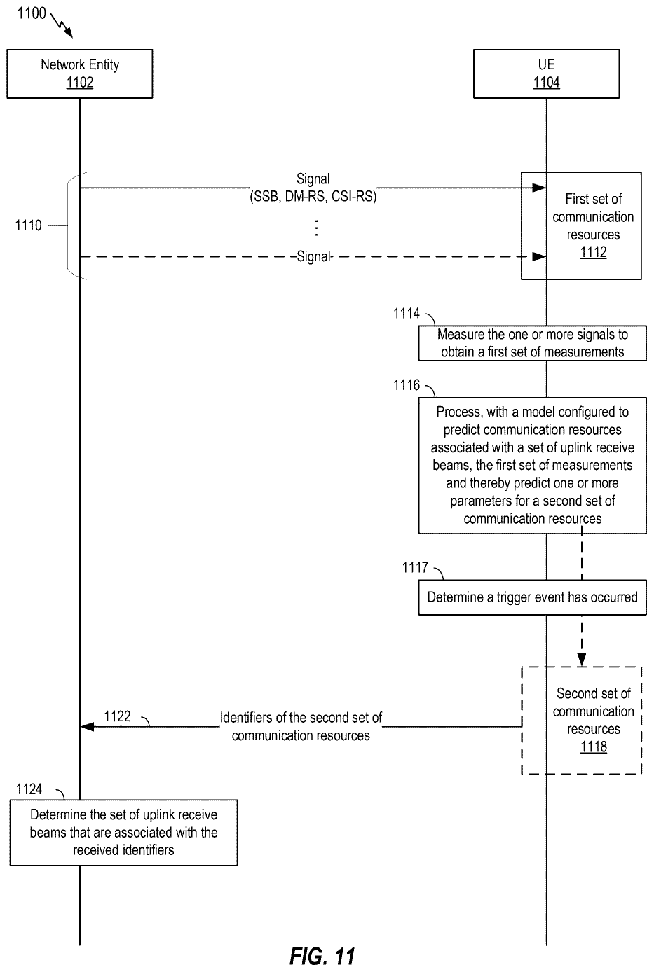

In some aspects, sending identifier(s) of predicted second set of communication resources, associated with second set of beams (e.g., at 922 in FIGS. 9 and 1022 in FIG. 10), is in response to a triggering event occurring at the UE. Transmission of the identifier(s) of the predicted second set of communication resources in response to a trigger event is illustrated in process flow 1100 of FIG. 11. Steps 1110, 1114, 1116, 1122, and 1124 in process flow 1100 are identical to steps 910, 914, 916, 922, and 924 in process flow 900 of FIG. 9, described above. However, unlike process flow 900, in process flow 1100, sending the identifier(s) of the predicted second set of communication resources, at step 1122 to the network entity (e.g., network entity 1102), is performed when a trigger event occurs. For example, at step 1117, a UE (e.g., UE 1104) may determine that a trigger event has occurred, and based on making this determination, send the identifier(s) at step 1122.

The trigger event may be an event identified in the standards (e.g., 3GPP specification), a trigger event pre-configured by network entity 1102, and/or a trigger event based on UE 1104 feedback. Example trigger events may include a change in a direction of UE 1104, a change in a speed of UE 1104, a rotation of UE 1104, movement of UE 1104, and/or the like.

As discussed, in some aspects, the second set of communication resources are virtual resources. Accordingly, in certain aspects, the network entity configures the UE, such as using RRC messages/configuration, with a (e.g., a downlink/joint or uplink) transmission configuration indicator (TCI) state associated with one or more virtual resources. For example, the reference source for Type D-quasi co-location associated with the TCI state may be based on the second set of communication resources reported by the UE, such as at step 922 of FIG. 9.

In some aspects, after determining the set of uplink receive beams that are to be used for uplink communication with the UE (and are associated with the received identifier(s) of the second set of communication resources) (e.g., at step 924 in FIG. 9), the network entity, may send an indication (e.g., in a MAC-CE) to the UE to activate one or more TCI states including the TCI state associated with one or more virtual resources. The network entity, in certain aspects, may further send an indication to the UE to switch its DL/joint or uplink TCI state to the TCI state associated with one or more virtual resources. Accordingly, the UE may use the uplink transmit beam associated with the second set of communication resources, as discussed, for transmitting communications (e.g., sound reference signals (SRSs), physical uplink control channel (PUCCH) data, physical uplink shared channel (PUSCH) data, uplink DM-RS, and/or the like) to the network entity.

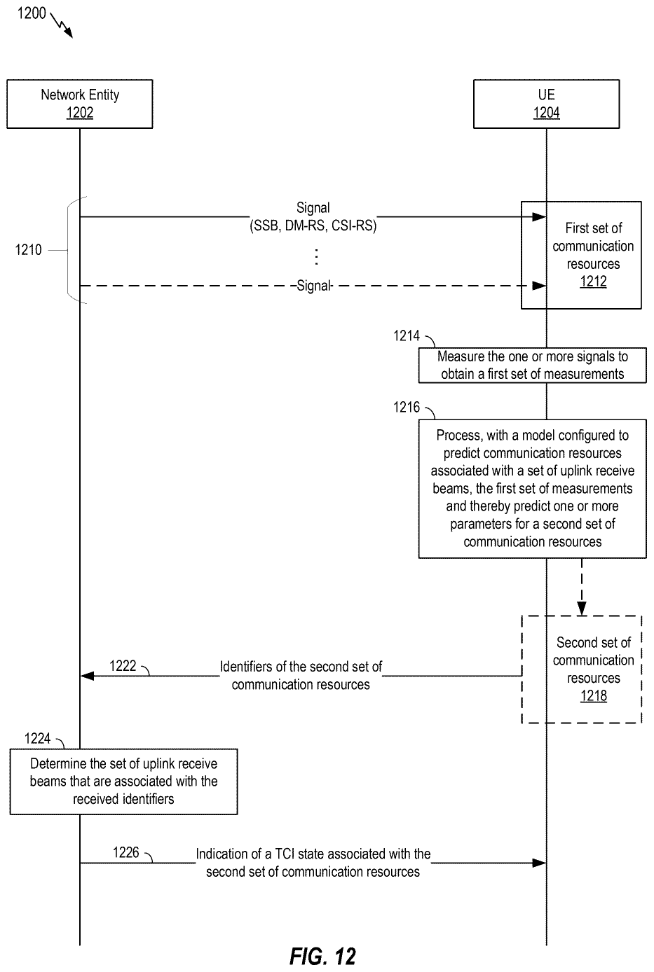

Example transmission of an indication of a TCI state is illustrated in process flow 1200 of FIG. 12. Steps 1210, 1214, 1216, 1222, and 1224 in process flow 1200 are identical to steps 910, 914, 916, 922, and 924 in process flow 900 of FIG. 9, described above. However, unlike process flow 900, in process flow 1200, a network entity (e.g., network entity 1202) further sends to a UE (e.g., UE 1204) an indication of a TCI state associated with virtual resources associated with the uplink transmit/receive beams.

In some aspects, the indication of the TCI state is a MAC-CE activating the TCI state of UE 1204. In some aspects, the indication of the TCI state is received in a DCI requesting UE 1204 switch its downlink/joint or uplink TCI-state to the indicated TCI-state. After switching its TCI-state to the indicated TCI-state, UE 1204 may use a set of uplink transmit beams associated with the TCI-state for transmitting sound reference signals (SRSs), physical uplink control channel (PUCCH) data, physical uplink shared channel (PUSCH) data, uplink DM-RS, and/or the like.

### Example Operations by an Apparatus

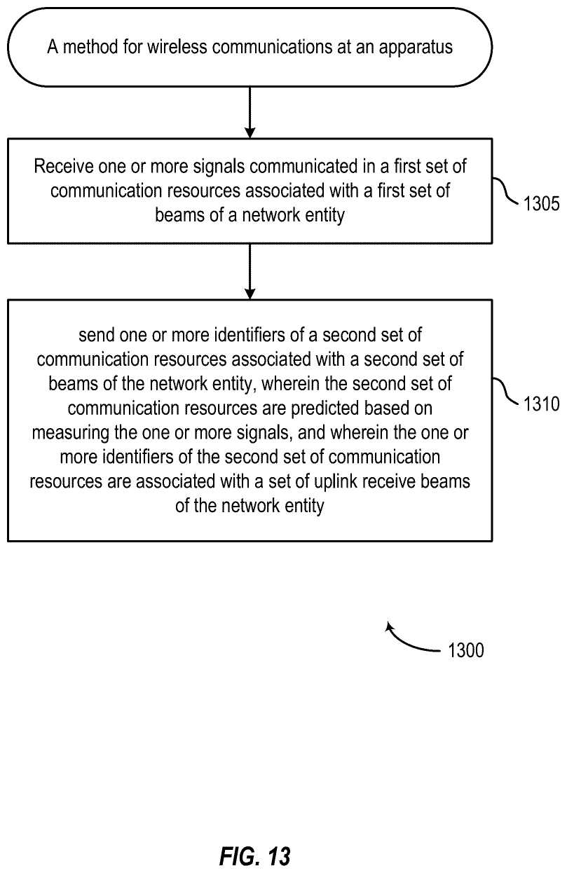

FIG. 13 shows a method 1300 for wireless communications at an apparatus, such as UE 104 of FIGS. 1 and 3.

Method 1300 begins at step 1305 with receiving one or more signals communicated in a first set of communication resources associated with a first set of beams of a network entity.

Method 1300 then proceeds to step 1310 with sending one or more identifiers of a second set of communication resources associated with a second set of beams of the network entity, wherein the second set of communication resources are predicted based on measuring the one or more signals, and wherein the one or more identifiers of the second set of communication resources are associated with a set of uplink receive beams of the network entity.

In certain aspects, method 1300 further includes receiving a request to predict the second set of communication resources.

In certain aspects, method 1300 further includes sending an indication that the second set of communication resources are predicted.

In certain aspects, the first set of beams and the second set of beams correspond to different sets of beams, and the first set of communication resources and the second set of communication resources correspond to the same time and frequency resources.

In certain aspects, the first set of beams and the second set of beams correspond to the same set of beams, the first set of communication resources and the second set of communication resources correspond to the same frequency resources, and the first set of communication resources and the second set of communication resources correspond to different time resources, the first set of communication resources occurring earlier in time than the second set of communication resources.

In certain aspects, the first set of beams and the second set of beams correspond to different sets of beams, the first set of communication resources and the second set of communication resources correspond to the same frequency resources, and the first set of communication resources and the second set of communication resources correspond to different time resources, the first set of communication resources occurring earlier in time than the second set of communication resources.

In certain aspects, the first set of beams and the second set of beams correspond to the same set of beams, the first set of communication resources and the second set of communication resources correspond to different frequency resources, and the first set of communication resources and the second set of communication resources correspond to the same time resources.

In certain aspects, the first set of beams and the second set of beams correspond to different sets of beams, the first set of communication resources and the second set of communication resources correspond to different frequency resources, and the first set of communication resources and the second set of communication resources correspond to the same time resources.

In certain aspects, the first set of beams and the second set of beams correspond to the same set of beams, the first set of communication resources and the second set of communication resources correspond to different frequency resources, and the first set of communication resources and the second set of communication resources correspond to different time resources, the first set of communication resources occurring earlier in time than the second set of communication resources.

In certain aspects, the first set of beams and the second set of beams correspond to different sets of beams, the first set of communication resources and the second set of communication resources correspond to different frequency resources, and the first set of communication resources and the second set of communication resources correspond to different time resources, the first set of communication resources occurring earlier in time than the second set of communication resources.

In certain aspects, method 1300 further includes sending an indication that the UE is capable of predicting the second set of communication resources.

In certain aspects, method 1300 further includes receiving an indication of one or more minimum requirements for uplink transmission from the UE to the network entity; and selecting the second set of communication resources based on the one or more minimum requirements.

In certain aspects, the one or more minimum requirements include one or more of: spectral efficiency; throughput; signal to noise ratio; or reference signal receive power.

In certain aspects, the indication of the one or more minimum requirements is received in one of: a radio resource control (RRC) message; a channel state information (CSI) report setting; an aperiodic CSI report configuration; a medium access control (MAC) control element (MAC-CE); or downlink control information.

In certain aspects, method 1300 further includes sending an indication of one or more parameters associated with downlink transmission from the network entity to the UE, wherein the indication of the one or more minimum requirements comprises an indication of one or more offsets between the one or more parameters and the one or more minimum requirements.

In certain aspects, one or more second signals are transmitted by the network entity in the second set of communication resources.

In certain aspects, one or more second signals are not transmitted by the network entity in the second set of communication resources.

In certain aspects, the one or more signals include one or more of: one or more synchronization signal blocks; one or more demodulation reference signals; or one or more channel state information reference signals.

In certain aspects, method 1300 further includes receiving an indication of the second set of beams.

In certain aspects, the indication of the second set of beams indicates one or more of beam direction, beam width, or beamforming gain associated with second set of beams.

In certain aspects, the indication of the second set of beams comprises one or more offsets between one or more first parameters of the first set of beams and one or more second parameters of the second set of beams.

In certain aspects, the indication of the second set of beams is received via one of: a radio resource control (RRC) message; a channel state information (CSI) report setting; an aperiodic CSI report configuration; a medium access control (MAC) control element (MAC-CE); or downlink control information.

In certain aspects, the one or more identifiers are sent in one of: a channel state information (CSI) report; or a medium access control (MAC) control element (MAC-CE).

In certain aspects, sending the one or more identifiers is in response to a trigger event occurring at the UE.

In certain aspects, method 1300 further includes sending one or more indications of one or more of: a predicted reference signal receive power (RSRP) for downlink communication associated with the second set of communication resources; a predicted RSRP for uplink communication associated with the second set of communication resources; a predicted signal to interference plus noise (SINR) for downlink communication associated with the second set of communication resources; a predicted SINR for uplink communication associated with the second set of communication resources; a predicted angle of arrival for downlink communication associated with the second set of communication resources; a predicted angle of arrival for uplink communication associated with the second set of communication resources; a predicted angle of departure for downlink communication associated with the second set of communication resources; or a predicted angle of departure for uplink communication associated with the second set of communication resources.

In certain aspects, the second set of communication resources comprises one or more virtual resources, and method 1300 further includes receiving an indication of a transmission configuration indicator (TCI) state associated with the one or more virtual resources.

In certain aspects, each uplink receive beam of the set of uplink receive beams of the network entity corresponds to one or more of a corresponding amplitude weighting pattern to apply to signals received over each of a plurality of antennas of the network entity or a corresponding phase shift pattern to apply to signals received over each of the plurality of antennas of the network entity.

In certain aspects, the second set of beams comprises the set of uplink receive beams.

In certain aspects, the second set of beams comprises a set of downlink transmit beams of the network entity.

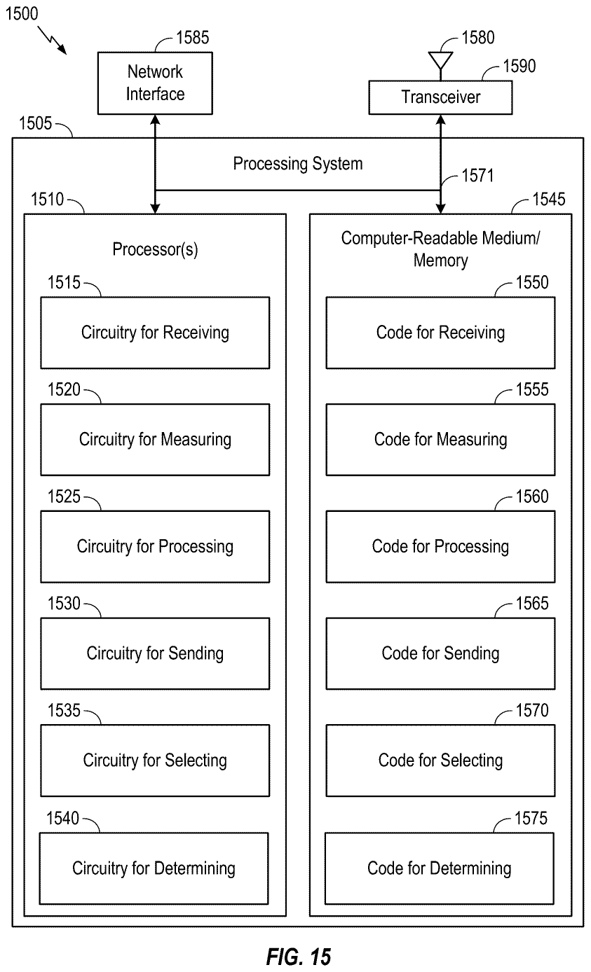

In certain aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Operations by an Apparatus

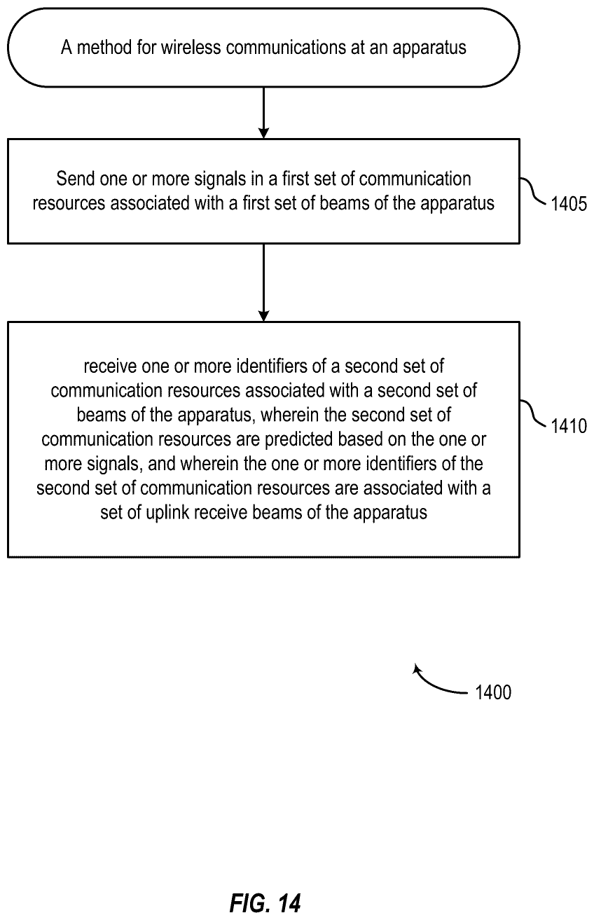

FIG. 14 shows a method 1400 for wireless communications at an apparatus, such as a network entity, such as BS 102 of FIGS. 1 and 3, or a disaggregated base station as discussed with respect to FIG. 2.

Method 1400 begins at step 1405 with sending one or more signals in a first set of communication resources associated with a first set of beams of the network entity.

Method 1400 then proceeds to step 1410 with receiving one or more identifiers of a second set of communication resources associated with a second set of beams of the network entity, wherein the second set of communication resources are predicted based on the one or more signals, and wherein the one or more identifiers of the second set of communication resources are associated with a set of uplink receive beams of the network entity.

In certain aspects, method 1400 further includes sending a request to predict the second set of communication resources.

In certain aspects, method 1400 further includes receiving an indication that the second set of communication resources are predicted.

In certain aspects, the first set of beams and the second set of beams correspond to different sets of beams, and the first set of communication resources and the second set of communication resources correspond to the same time and frequency resources.

In certain aspects, the first set of beams and the second set of beams correspond to the same set of beams, the first set of communication resources and the second set of communication resources correspond to the same frequency resources, and the first set of communication resources and the second set of communication resources correspond to different time resources, the first set of communication resources occurring earlier in time than the second set of communication resources.

In certain aspects, the first set of beams and the second set of beams correspond to different sets of beams, the first set of communication resources and the second set of communication resources correspond to the same frequency resources, and the first set of communication resources and the second set of communication resources correspond to different time resources, the first set of communication resources occurring earlier in time than the second set of communication resources.

In certain aspects, the first set of beams and the second set of beams correspond to the same set of beams, the first set of communication resources and the second set of communication resources correspond to different frequency resources, and the first set of communication resources and the second set of communication resources correspond to the same time resources.

In certain aspects, the first set of beams and the second set of beams correspond to different sets of beams, the first set of communication resources and the second set of communication resources correspond to different frequency resources, and the first set of communication resources and the second set of communication resources correspond to the same time resources.

In certain aspects, the first set of beams and the second set of beams correspond to the same set of beams, the first set of communication resources and the second set of communication resources correspond to different frequency resources, and the first set of communication resources and the second set of communication resources correspond to different time resources, the first set of communication resources occurring earlier in time than the second set of communication resources.

In certain aspects, the first set of beams and the second set of beams correspond to different sets of beams, the first set of communication resources and the second set of communication resources correspond to different frequency resources, and the first set of communication resources and the second set of communication resources correspond to different time resources, the first set of communication resources occurring earlier in time than the second set of communication resources.

In certain aspects, method 1400 further includes receiving an indication that a user equipment is capable of predicting the second set of communication resources.

In certain aspects, method 1400 further includes sending an indication of one or more minimum requirements for uplink transmission from the network entity to a user equipment.

In certain aspects, the one or more minimum requirements comprise one or more of: spectral efficiency; throughput; signal to noise ratio; or reference signal receive power.

In certain aspects, the indication of the one or more minimum requirements is sent in one of: a radio resource control (RRC) message; a channel state information (CSI) report setting; an aperiodic CSI report configuration; a medium access control (MAC) control element (MAC-CE); or downlink control information.

In certain aspects, method 1400 further includes receiving an indication of one or more parameters associated with downlink transmission from the network entity, wherein the indication of the one or more minimum requirements comprises an indication of one or more offsets between the one or more parameters and the one or more minimum requirements.

In certain aspects, method 1400 further includes sending one or more second signals in the second set of communication resources.

In certain aspects, one or more second signals are not transmitted by the network entity in the second set of communication resources.

In certain aspects, the one or more signals comprise one or more of: one or more synchronization signal blocks; one or more demodulation reference signals; or one or more channel state information reference signals.

In certain aspects, method 1400 further includes sending an indication of the second set of beams.

In certain aspects, the indication of the second set of beams indicates one or more of beam direction, beam width, or beamforming gain associated with second set of beams.

In certain aspects, the indication of the second set of beams comprises one or more offsets between one or more first parameters of the first set of beams and one or more second parameters of the second set of beams.

In certain aspects, the indication of the second set of beams is sent in one of: a radio resource control (RRC) message; a channel state information (CSI) report setting; an aperiodic CSI report configuration; a medium access control (MAC) control element (MAC-CE); or downlink control information.

In certain aspects, the one or more identifiers are received in one of: a channel state information (CSI) report; or a medium access control (MAC) control element (MAC-CE).

In certain aspects, method 1400 further includes receiving one or more indications of one or more of: a predicted reference signal receive power (RSRP) for downlink communication associated with the second set of communication resources; a predicted RSRP for uplink communication associated with the second set of communication resources; a predicted signal to interference plus noise (SINR) for downlink communication associated with the second set of communication resources; a predicted SINR for uplink communication associated with the second set of communication resources; a predicted angle of arrival for downlink communication associated with the second set of communication resources; a predicted angle of arrival for uplink communication associated with the second set of communication resources; a predicted angle of departure for downlink communication associated with the second set of communication resources; or a predicted angle of departure for uplink communication associated with the second set of communication resources.

In certain aspects, the second set of communication resources comprises one or more virtual resources, and method 1400 further includes sending an indication of a transmission configuration indicator (TCI) state associated with the one or more virtual resources.

In certain aspects, each uplink receive beam of the set of uplink receive beams corresponds to one or more of a corresponding amplitude weighting pattern to apply to signals received over each of a plurality of antennas of the network entity or a corresponding phase shift pattern to apply to signals received over each of the plurality of antennas of the network entity.

In certain aspects, the second set of beams comprises the set of uplink receive beams.

In certain aspects, the second set of beams comprises a set of downlink transmit beams of the network entity.

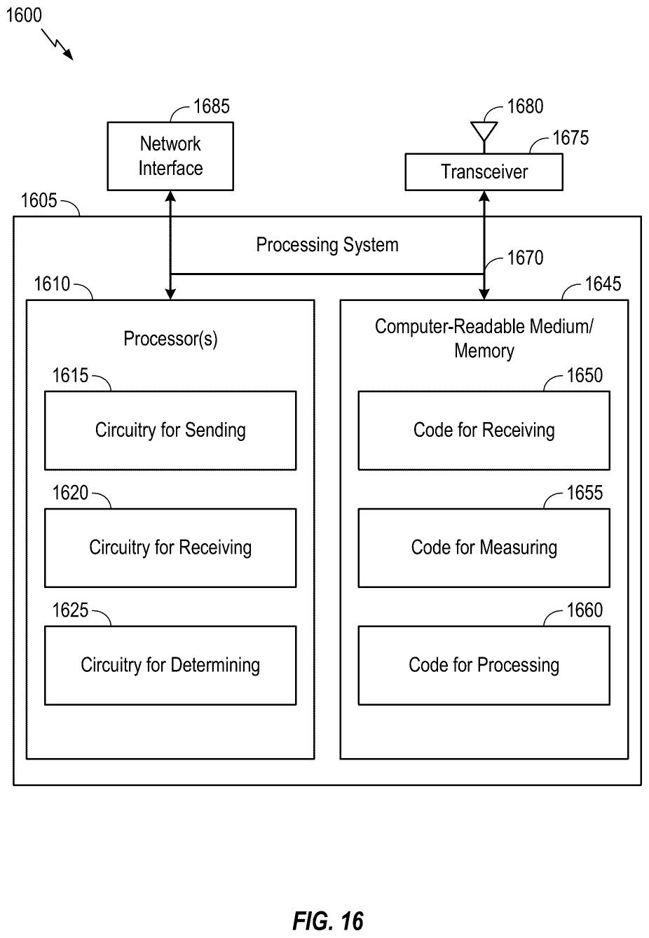

In certain aspects, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

### Example Communications Devices

FIG. 15 depicts aspects of an example communications device 1500. In some aspects, communications device 1500 is a user equipment, such as UE 104 described above with respect to FIGS. 1 and 3.

The communications device 1500 includes a processing system 1505 coupled to a transceiver 1590 (e.g., a transmitter and/or a receiver) and/or a network interface 1585. The transceiver 1590 is configured to transmit and receive signals for the communications device 1500 via an antenna 1580, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1545 via a bus 1571. In certain aspects, the computer-readable medium/memory 1545 is configured to store instructions (e.g., computer-executable code) that when executed by the one or more processors 1510, enable and cause the one or more processors 1510 to perform the method 1300 described with respect to FIG. 13, or any aspect related to it, including any additional steps or sub-steps described in relation to FIG. 13. Note that reference to a processor performing a function of communications device 1500 may include one or more processors performing that function of communications device 1500, such as in a distributed fashion.

In the depicted example, computer-readable medium/memory 1545 stores code for receiving 1550, code for measuring 1555, code for processing 1560, code for sending 1565, code for selecting 1570, and code for determining 1575. Processing of the code 1550-1575 may enable and cause the communications device 1500 to perform the method 1300 described with respect to FIG. 13, or any aspect related to it.

The one or more processors 1510 include circuitry configured to implement (e.g., execute) the code stored in the computer-readable medium/memory 1545, including circuitry for receiving 1515, circuitry for measuring 1520, circuitry for processing 1525, circuitry for sending 1530, circuitry for selecting 1535, and circuitry for determining 1540. Processing with circuitry 1515-1540 may enable and cause the communications device 1500 to perform the method 1300 described with respect to FIG. 13, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1590 and/or antenna 1580 of the communications device 1500 in FIG. 15, and/or one or more processors 1510 of the communications device 1500 in FIG. 15. Means for communicating, receiving or obtaining may include the transceivers 354, antenna(s) 352, receive processor 358, and/or controller/processor 380 of the UE 104 illustrated in FIG. 3, transceiver 1590 and/or antenna 1580 of the communications device 1500 in FIG. 15, and/or one or more processors 1510 of the communications device 1500 in FIG. 15. Means for measuring, processing, selecting, and determining may include the controller/processor 380 of the UE 104 illustrated in FIG. 3, and/or one or more processors 1510 of the communications device 1500 in FIG. 15.

FIG. 16 depicts aspects of an example communications device 1600. In some aspects, communications device 1600 is a network entity, such as BS 102 of FIGS. 1 and 3 or a disaggregated base station as discussed with respect to FIG. 2.

The communications device 1600 includes a processing system 1605 coupled to a transceiver 1675 (e.g., a transmitter and/or a receiver) and/or a network interface 1685. The transceiver 1675 is configured to transmit and receive signals for the communications device 1600 via an antenna 1680, such as the various signals as described herein. The network interface 1685 is configured to obtain and send signals for the communications device 1600 via communications link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1645 via a bus 1670. In certain aspects, the computer-readable medium/memory 1645 is configured to store instructions (e.g., computer-executable code) that when executed by the one or more processors 1610, enable and cause the one or more processors 1610 to perform the method 1400 described with respect to FIG. 14, or any aspect related to it, including any additional steps or sub-steps described in relation to FIG. 14. Note that reference to a processor of communications device 1600 performing a function may include one or more processors of communications device 1600 performing that function, such as in a distributed fashion.

In the depicted example, the computer-readable medium/memory 1645 stores code for receiving 1650, code for measuring 1655, and code for processing 1660. Processing of the code 1650-1660 may enable and cause the communications device 1600 to perform the method 1400 described with respect to FIG. 14, or any aspect related to it.

The one or more processors 1610 include circuitry configured to implement (e.g., execute) the code stored in the computer-readable medium/memory 1645, including circuitry for sending 1615, circuity for receiving 1620, and circuitry for determining 1625. Processing with circuitry 1615-1625 may enable and cause the communications device 1600 to perform the method 1400 described with respect to FIG. 14, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1675 and/or antenna 1680 of the communications device 1600 in FIG. 16, and/or one or more processors 1610 of the communications device 1600 in FIG. 16. Means for communicating, receiving or obtaining may include the transceivers 332, antenna(s) 334, receive processor 338, and/or controller/processor 340 of the BS 102 illustrated in FIG. 3, transceiver 1675 and/or antenna 1680 of the communications device 1600 in FIG. 16, and/or one or more processors 1610 of the communications device 1600 in FIG. 16. Means for determining may include the controller/processor 340 of the BS 102 illustrated in FIG. 3, and/or one or more processors 1610 of the communications device 1600 in FIG. 16.

### Example Clauses

Implementation examples are described in the following numbered clauses:

Clause 1: A method for wireless communications by an apparatus comprising: receiving one or more signals communicated in a first set of communication resources associated with a first set of beams of a network entity; and sending one or more identifiers of a second set of communication resources associated with a second set of beams of the network entity, wherein the second set of communication resources are predicted based on measuring the one or more signals, and wherein the one or more identifiers of the second set of communication resources are associated with a set of uplink receive beams of the network entity.

Clause 2: The method of Clause 1, further comprising: receiving a request to predict the second set of communication resources.

Clause 3: The method of any one of Clauses 1-2, further comprising: sending an indication that the second set of communication resources are predicted.

Clause 4: The method of any one of Clauses 1-3, wherein: the first set of beams and the second set of beams correspond to different sets of beams, and the first set of communication resources and the second set of communication resources correspond to the same time and frequency resources.

Clause 5: The method any one of Clauses 1-3, wherein: the first set of beams and the second set of beams correspond to the same set of beams, the first set of communication resources and the second set of communication resources correspond to the same frequency resources, and the first set of communication resources and the second set of communication resources correspond to different time resources, the first set of communication resources occurring earlier in time than the second set of communication resources.

Clause 6: The method any one of Clauses 1-3, wherein: the first set of beams and the second set of beams correspond to different sets of beams, the first set of communication resources and the second set of communication resources correspond to the same frequency resources, and the first set of communication resources and the second set of communication resources correspond to different time resources, the first set of communication resources occurring earlier in time than the second set of communication resources.

Clause 7: The method any one of Clauses 1-3, wherein: the first set of beams and the second set of beams correspond to the same set of beams, the first set of communication resources and the second set of communication resources correspond to different frequency resources, and the first set of communication resources and the second set of communication resources correspond to the same time resources.

Clause 8: The method any one of Clauses 1-3, wherein: the first set of beams and the second set of beams correspond to different sets of beams, the first set of communication resources and the second set of communication resources correspond to different frequency resources, and the first set of communication resources and the second set of communication resources correspond to the same time resources.

Clause 9: The method any one of Clauses 1-3, wherein: the first set of beams and the second set of beams correspond to the same set of beams, the first set of communication resources and the second set of communication resources correspond to different frequency resources, and the first set of communication resources and the second set of communication resources correspond to different time resources, the first set of communication resources occurring earlier in time than the second set of communication resources.

Clause 10: The method any one of Clauses 1-3, wherein: the first set of beams and the second set of beams correspond to different sets of beams, the first set of communication resources and the second set of communication resources correspond to different frequency resources, and the first set of communication resources and the second set of communication resources correspond to different time resources, the first set of communication resources occurring earlier in time than the second set of communication resources.

Clause 11: The method any one of Clauses 1-10, further comprising: sending an indication that the UE is capable of predicting the second set of communication resources.

Clause 12: The method any one of Clauses 1-11, further comprising: receiving an indication of one or more minimum requirements for uplink transmission from the UE to the network entity; and selecting the second set of communication resources based on the one or more minimum requirements.

Clause 13: The method of Clause 12, wherein the one or more minimum requirements comprise one or more of: spectral efficiency; throughput; signal to noise ratio; or reference signal receive power.

Clause 14: The method any one of Clauses 12-13, wherein the indication of the one or more minimum requirements is received in one of: a radio resource control (RRC) message; a channel state information (CSI) report setting; an aperiodic CSI report configuration; a medium access control (MAC) control element (MAC-CE); or downlink control information.

Clause 15: The method any one of Clauses 12-14, further comprising: sending an indication of one or more parameters associated with downlink transmission from the network entity to the UE, wherein the indication of the one or more minimum requirements comprises an indication of one or more offsets between the one or more parameters and the one or more minimum requirements.

Clause 16: The method any one of Clauses 1-15, wherein one or more second signals are transmitted by the network entity in the second set of communication resources.

Clause 17: The method any one of Clauses 1-15, wherein one or more second signals are not transmitted by the network entity in the second set of communication resources.

Clause 18: The method any one of Clauses 1-17, wherein the one or more signals comprise one or more of: one or more synchronization signal blocks; one or more demodulation reference signals; or one or more channel state information reference signals.

Clause 19: The method any one of Clauses 1-18, further comprising: receiving an indication of the second set of beams.

Clause 20: The method of Clause 19, wherein the indication of the second set of beams indicates one or more of beam direction, beam width, or beamforming gain associated with second set of beams.

Clause 21: The method any one of Clauses 19-20, wherein the indication of the second set of beams comprises one or more offsets between one or more first parameters of the first set of beams and one or more second parameters of the second set of beams.

Clause 22: The method any one of Clauses 19-21, wherein the indication of the second set of beams is received via one of: a radio resource control (RRC) message; a channel state information (CSI) report setting; an aperiodic CSI report configuration; a medium access control (MAC) control element (MAC-CE); or downlink control information.

Clause 23: The method any one of Clauses 1-22, wherein the one or more identifiers are sent in one of: a channel state information (CSI) report; or a medium access control (MAC) control element (MAC-CE).

Clause 24: The method any one of Clauses 1-23, wherein sending the one or more identifiers is in response to a trigger event occurring at the UE.

Clause 25: The method any one of Clauses 1-24, further comprising: sending one or more indications of one or more of: a predicted reference signal receive power (RSRP) for downlink communication associated with the second set of communication resources; a predicted RSRP for uplink communication associated with the second set of communication resources; a predicted signal to interference plus noise (SINR) for downlink communication associated with the second set of communication resources; a predicted SINR for uplink communication associated with the second set of communication resources; a predicted angle of arrival for downlink communication associated with the second set of communication resources; a predicted angle of arrival for uplink communication associated with the second set of communication resources; a predicted angle of departure for downlink communication associated with the second set of communication resources; or a predicted angle of departure for uplink communication associated with the second set of communication resources.

Clause 26: The method any one of Clauses 1-15 and 17-25, wherein the second set of communication resources comprises one or more virtual resources, and the method further comprises: receiving an indication of a transmission configuration indicator (TCI) state associated with the one or more virtual resources.

Clause 27: The method any one of Clauses 1-26, wherein each uplink receive beam of the set of uplink receive beams of the network entity corresponds to one or more of a corresponding amplitude weighting pattern to apply to signals received over each of a plurality of antennas of the network entity or a corresponding phase shift pattern to apply to signals received over each of the plurality of antennas of the network entity.

Clause 28: The method any one of Clauses 1-27, wherein the second set of beams comprises the set of uplink receive beams.

Clause 29: The method any one of Clauses 1-27, wherein the second set of beams comprises a set of downlink transmit beams of the network entity.

Clause 30: A method for wireless communications by a network entity comprising: sending one or more signals in a first set of communication resources associated with a first set of beams of the network entity; and receiving one or more identifiers of a second set of communication resources associated with a second set of beams of the network entity, wherein the second set of communication resources are predicted based on the one or more signals, and wherein the one or more identifiers of the second set of communication resources are associated with a set of uplink receive beams of the network entity.

Clause 31: The method of Clause 30, further comprising sending a request to predict the second set of communication resources.

Clause 32: The method of any one of Clauses 30-31, further comprising receiving an indication that the second set of communication resources are predicted.

Clause 33: The method of any one of Clauses 30-32, wherein: the first set of beams and the second set of beams correspond to different sets of beams, and the first set of communication resources and the second set of communication resources correspond to the same time and frequency resources.

Clause 34: The method of any one of Clauses 30-32, wherein: the first set of beams and the second set of beams correspond to the same set of beams, the first set of communication resources and the second set of communication resources correspond to the same frequency resources, and the first set of communication resources and the second set of communication resources correspond to different time resources, the first set of communication resources occurring earlier in time than the second set of communication resources.

Clause 35: The method of any one of Clauses 30-32, wherein: the first set of beams and the second set of beams correspond to different sets of beams, the first set of communication resources and the second set of communication resources correspond to the same frequency resources, and the first set of communication resources and the second set of communication resources correspond to different time resources, the first set of communication resources occurring earlier in time than the second set of communication resources.

Clause 36: The method of any one of Clauses 30-32, wherein: the first set of beams and the second set of beams correspond to the same set of beams, the first set of communication resources and the second set of communication resources correspond to different frequency resources, and the first set of communication resources and the second set of communication resources correspond to the same time resources.

Clause 37: The method of any one of Clauses 30-32, wherein: the first set of beams and the second set of beams correspond to different sets of beams, the first set of communication resources and the second set of communication resources correspond to different frequency resources, and the first set of communication resources and the second set of communication resources correspond to the same time resources.

Clause 38: The method of any one of Clauses 30-32, wherein: the first set of beams and the second set of beams correspond to the same set of beams, the first set of communication resources and the second set of communication resources correspond to different frequency resources, and the first set of communication resources and the second set of communication resources correspond to different time resources, the first set of communication resources occurring earlier in time than the second set of communication resources.

Clause 39: The method of any one of Clauses 30-32, wherein: the first set of beams and the second set of beams correspond to different sets of beams, the first set of communication resources and the second set of communication resources correspond to different frequency resources, and the first set of communication resources and the second set of communication resources correspond to different time resources, the first set of communication resources occurring earlier in time than the second set of communication resources.

Clause 40: The method of any one of Clauses 30-39, further comprising receiving an indication that a user equipment is capable of predicting the second set of communication resources.

Clause 41: The method of any one of Clauses 30-40, further comprising sending an indication of one or more minimum requirements for uplink transmission from the network entity to a user equipment.

Clause 42: The method of Clause 41, wherein the one or more minimum requirements comprise one or more of: spectral efficiency; throughput; signal to noise ratio; or reference signal receive power.

Clause 43: The method of any one of Clauses 41-42, the indication of the one or more minimum requirements is sent in one of: a radio resource control (RRC) message; a channel state information (CSI) report setting; an aperiodic CSI report configuration; a medium access control (MAC) control element (MAC-CE); or downlink control information.

Clause 44: The method of any one of Clauses 41-43, further comprising receiving an indication of one or more parameters associated with downlink transmission from the network entity, wherein the indication of the one or more minimum requirements comprises an indication of one or more offsets between the one or more parameters and the one or more minimum requirements.

Clause 45: The method of any one of Clauses 30-44, further comprising sending one or more second signals in the second set of communication resources.

Clause 46: The method of any one of Clauses 30-44, wherein one or more second signals are not transmitted by the network entity in the second set of communication resources.

Clause 47: The method of any one of Clauses 30-46, wherein the one or more signals comprise one or more of: one or more synchronization signal blocks; one or more demodulation reference signals; or one or more channel state information reference signals.

Clause 48: The method of any one of Clauses 30-47, further comprising sending an indication of the second set of beams.

Clause 49: The method of Clause 48, wherein the indication of the second set of beams indicates one or more of beam direction, beam width, or beamforming gain associated with second set of beams.

Clause 50: The method of any one of Clauses 48-49, wherein the indication of the second set of beams comprises one or more offsets between one or more first parameters of the first set of beams and one or more second parameters of the second set of beams.

Clause 51: The method of any one of Clauses 48-50, wherein the indication of the second set of beams is sent in one of: a radio resource control (RRC) message; a channel state information (CSI) report setting; an aperiodic CSI report configuration; a medium access control (MAC) control element (MAC-CE); or downlink control information.

Clause 52: The method of any one of Clauses 30-51, wherein the one or more identifiers are received in one of: a channel state information (CSI) report; or a medium access control (MAC) control element (MAC-CE).

Clause 53: The method of any one of Clauses 30-52, further comprising: receiving one or more indications of one or more of: a predicted reference signal receive power (RSRP) for downlink communication associated with the second set of communication resources; a predicted RSRP for uplink communication associated with the second set of communication resources; a predicted signal to interference plus noise (SINR) for downlink communication associated with the second set of communication resources; a predicted SINR for uplink communication associated with the second set of communication resources; a predicted angle of arrival for downlink communication associated with the second set of communication resources; a predicted angle of arrival for uplink communication associated with the second set of communication resources; a predicted angle of departure for downlink communication associated with the second set of communication resources; or a predicted angle of departure for uplink communication associated with the second set of communication resources.

Clause 54: The method of any one of Clauses 30-44 and 46-53, wherein the second set of communication resources comprises one or more virtual resources, and the method further comprises sending an indication of a transmission configuration indicator (TCI) state associated with the one or more virtual resources.

Clause 55: The method of any one of Clauses 30-54, wherein each uplink receive beam of the set of uplink receive beams corresponds to one or more of a corresponding amplitude weighting pattern to apply to signals received over each of a plurality of antennas of the network entity or a corresponding phase shift pattern to apply to signals received over each of the plurality of antennas of the network entity.

Clause 56: The method of any one of Clauses 30-55, wherein the second set of beams comprises the set of uplink receive beams.

Clause 57: The method of any one of Clauses 30-55, wherein the second set of beams comprises a set of downlink transmit beams of the network entity.

Clause 58: The method of any one of Clauses 30-57, further comprising processing, using a machine learning model configured to predict communication resources associated with a set of beams, the measured one or more signals and thereby predict one or more parameters for the second set of communication resources.

Clause 59: One or more apparatuses, comprising: one or more memories comprising executable instructions; and one or more processors configured to execute the executable instructions and cause the one or more apparatuses to perform a method in accordance with any one of Clauses 1-58.

Clause 60: One or more apparatuses, comprising means for performing a method in accordance with any one of Clauses 1-58.

Clause 61: One or more non-transitory computer-readable media comprising executable instructions that, when executed by one or more processors of one or more apparatuses, cause the one or more apparatuses to perform a method in accordance with any one of Clauses 1-58.

Clause 62: One or more computer program products embodied on one or more computer-readable storage media comprising code for performing a method in accordance with any one of Clauses 1-58.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” For example, reference to “a processor,” “a controller,” “a memory,” etc., unless otherwise specifically stated, should be understood to refer to “one or more processors,” “one or more controllers,” “one or more memories,” etc. Further, where reference is made in a claim to one or more elements performing functions, it should be understood, unless otherwise specifically stated, that each function need not be performed by each of the one or more elements, but rather the functions may be performed by the one or more elements in a distributed fashion. For example, in a claim with a first processor and a second processor configured to perform a first function and a second function, the first function may be performed by the first processor, the second processor, or both the first processor and the second processor, and the second function may be performed by first processor, the second processor, or both the first processor and the second processor. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

1. An apparatus configured for wireless communications, comprising:
one or more memories comprising processor-executable instructions; and
one or more processors configured to execute the processor-executable instructions and cause the apparatus to:
receive one or more signals communicated in a first set of communication resources associated with a first set of beams of a network entity; and
send one or more identifiers of a second set of communication resources associated with a second set of beams of the network entity, wherein the second set of communication resources are predicted based on measuring the one or more signals, and wherein the one or more identifiers of the second set of communication resources are associated with a set of uplink receive beams of the network entity.

2. The apparatus of claim 1, wherein the one or more processors are configured to execute the processor-executable instructions and further cause the apparatus to:
receive a request to predict the second set of communication resources.

3. The apparatus of claim 1, wherein the one or more processors are configured to execute the processor-executable instructions and further cause the apparatus to:
send an indication that the second set of communication resources are predicted.

4. The apparatus of claim 1, wherein:
the first set of beams and the second set of beams correspond to different sets of beams, and
the first set of communication resources and the second set of communication resources correspond to the same time and frequency resources.

5. The apparatus of claim 1, wherein:
the first set of beams and the second set of beams correspond to the same set of beams,
the first set of communication resources and the second set of communication resources correspond to the same frequency resources, and
the first set of communication resources and the second set of communication resources correspond to different time resources, the first set of communication resources occurring earlier in time than the second set of communication resources.

6. The apparatus of claim 1, wherein:
the first set of beams and the second set of beams correspond to different sets of beams,
the first set of communication resources and the second set of communication resources correspond to the same frequency resources, and
the first set of communication resources and the second set of communication resources correspond to different time resources, the first set of communication resources occurring earlier in time than the second set of communication resources.

7. The apparatus of claim 1, wherein:
the first set of beams and the second set of beams correspond to the same set of beams,
the first set of communication resources and the second set of communication resources correspond to different frequency resources, and
the first set of communication resources and the second set of communication resources correspond to the same time resources.

8. The apparatus of claim 1, wherein:
the first set of beams and the second set of beams correspond to different sets of beams,
the first set of communication resources and the second set of communication resources correspond to different frequency resources, and
the first set of communication resources and the second set of communication resources correspond to the same time resources.

9. The apparatus of claim 1, wherein:
the first set of beams and the second set of beams correspond to the same set of beams,
the first set of communication resources and the second set of communication resources correspond to different frequency resources, and
the first set of communication resources and the second set of communication resources correspond to different time resources, the first set of communication resources occurring earlier in time than the second set of communication resources.

10. The apparatus of claim 1, wherein:
the first set of beams and the second set of beams correspond to different sets of beams,
the first set of communication resources and the second set of communication resources correspond to different frequency resources, and
the first set of communication resources and the second set of communication resources correspond to different time resources, the first set of communication resources occurring earlier in time than the second set of communication resources.

11. The apparatus of claim 1, wherein the one or more processors are configured to execute the processor-executable instructions and further cause the apparatus to:
send an indication that the apparatus is capable of predicting the second set of communication resources.

12. The apparatus of claim 1, wherein the one or more processors are configured to execute the processor-executable instructions and further cause the apparatus to:
receive an indication of one or more minimum requirements for uplink transmission from the apparatus to the network entity; and
select the second set of communication resources based on the one or more minimum requirements.

13. The apparatus of claim 12, wherein the one or more processors are configured to execute the processor-executable instructions and further cause the apparatus to:
send an indication of one or more parameters associated with downlink transmission from the network entity to the apparatus, wherein the indication of the one or more minimum requirements comprises an indication of one or more offsets between the one or more parameters and the one or more minimum requirements.

14. The apparatus of claim 1, wherein the one or more processors are configured to execute the processor-executable instructions and further cause the apparatus to:
receive an indication of the second set of beams.

15. The apparatus of claim 14, wherein the indication of the second set of beams indicates one or more of beam direction, beam width, or beamforming gain associated with the second set of beams.

16. The apparatus of claim 14, wherein the indication of the second set of beams comprises one or more offsets between one or more first parameters of the first set of beams and one or more second parameters of the second set of beams.

17. The apparatus of claim 1, wherein to send the one or more identifiers, the one or more processors are configured to cause the apparatus to send the one or more identifiers in response to a trigger event occurring at the apparatus.

18. The apparatus of claim 1, wherein the one or more processors are configured to execute the processor-executable instructions and further cause the apparatus to:
send one or more indications of one or more of:
a predicted reference signal receive power (RSRP) for downlink communication associated with the second set of communication resources;
a predicted RSRP for uplink communication associated with the second set of communication resources;
a predicted signal to interference plus noise (SINR) for downlink communication associated with the second set of communication resources;
a predicted SINR for uplink communication associated with the second set of communication resources;
a predicted angle of arrival for downlink communication associated with the second set of communication resources;
a predicted angle of arrival for uplink communication associated with the second set of communication resources;
a predicted angle of departure for downlink communication associated with the second set of communication resources; or
a predicted angle of departure for uplink communication associated with the second set of communication resources.

19. The apparatus of claim 1, wherein the second set of communication resources comprises one or more virtual resources, and wherein the one or more processors are configured to execute the processor-executable instructions and further cause the apparatus to:
receive an indication of a transmission configuration indicator (TCI) state associated with the one or more virtual resources.

20-22. (canceled)

23. An apparatus configured for wireless communications, comprising:
one or more memories comprising processor-executable instructions; and
one or more processors configured to execute the processor-executable instructions and cause the apparatus to:
send one or more signals in a first set of communication resources associated with a first set of beams of the apparatus; and
receive one or more identifiers of a second set of communication resources associated with a second set of beams of the apparatus, wherein the second set of communication resources are predicted based on the one or more signals, and wherein the one or more identifiers of the second set of communication resources are associated with a set of uplink receive beams of the apparatus.

24-30. (canceled)
